(19) United States
(12) Patent Application Publication
(10) Pub. No.: US 2026/0012381 A1
(43) Pub. Date: Jan. 8, 2026

(54) ON-OFF KEYING SIGNAL BASED ON OFDM WAVEFORM

(71) Applicant: Samsung Electronics Co., Ltd., Suwon-si (KR)

(72) Inventor: Jeongho Jeon, San Jose, CA (US)

(21) Appl. No.: 19/234,204

(22) Filed: Jun. 10, 2025

Related U.S. Application Data
(60) Provisional application No. 63/668,705, filed on Jul. 8, 2024.
(60) Provisional application No. 63/669,117, filed on Jul. 9, 2024.
(60) Provisional application No. 63/670,043, filed on Jul. 11, 2024.

(51) Int. Cl. H04L 27/04; H04W 4/70

(52) U.S. Cl. CPC H04L 27/04; H04W 4/70

(57) ABSTRACT

Apparatuses and methods for generating on-off keying (OOK) signal based on orthogonal frequency-division multiplexing (OFDM) waveform. A method for an Internet of Things (IoT) device to communicate with a reader includes receiving a preamble signal that includes a start indicator part (SIP) and a clock acquisition part (CAP), receiving a physical reader-to-device channel (PRDCH), and receiving a postamble signal. The preamble signal, the PRDCH, and the postamble signal are OOK modulated based on an OFDM waveform. The preamble signal is followed by the PRDCH without a gap. The PRDCH is followed by the postamble signal without a gap. When the postamble signal ends in during an OFDM symbol duration, a padding signal is included from the end of the postamble signal for a remainder of the OFDM symbol duration.

### CROSS-REFERENCE TO RELATED AND CLAIM OF PRIORITY

The present application claims priority under 35 U.S.C. § 119(e) to U.S. Provisional Patent Application No. 63/668,705 filed on Jul. 8, 2024, U.S. Provisional Patent Application No. 63/669,117 filed on Jul. 9, 2024, and U.S. Provisional Patent Application No. 63/670,043 filed on Jul. 11, 2024, which are hereby incorporated by reference in their entirety.

### TECHNICAL FIELD

The present disclosure relates generally to wireless communication systems and, more specifically, the present disclosure is related to apparatuses and methods for generating on-off keying signal based on orthogonal frequency-division multiplexing (OFDM) waveform.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to generating on-off keying signal based on an OFDM waveform.

In one embodiment, a method for an Internet of Things (IoT) device to communicate with a reader is provided. The method includes receiving a preamble signal that includes a start indicator part (SIP) and a clock acquisition part (CAP), receiving a physical reader-to-device channel (PRDCH), and receiving a postamble signal. The preamble signal, the PRDCH, and the postamble signal are on-off keying (OOK) modulated based on an OFDM waveform. The preamble signal is followed by the PRDCH without a gap. The PRDCH is followed by the postamble signal without a gap. When the postamble signal ends during an OFDM symbol duration, a padding signal is included from the end of the postamble signal for a remainder of the OFDM symbol duration.

In another embodiment, an IoT device is provided. The IoT device includes a transceiver configured to receive a preamble signal that includes a SIP and a CAP, receive a PRDCH, and receive a postamble signal. The preamble signal, the PRDCH, and the postamble signal are OOK modulated based on an OFDM waveform. The preamble signal is followed by the PRDCH without a gap. The PRDCH is followed by the postamble signal without a gap. When the postamble signal ends during an OFDM symbol duration, a padding signal is included from the end of the postamble signal for a remainder of the OFDM symbol duration.

In yet another embodiment, a reader is provided. The reader includes a transceiver configured to transmit a preamble signal that includes a SIP and a CAP, transmit a PRDCH, and transmit a postamble signal. The preamble signal, the PRDCH, and the postamble signal are OOK modulated based on an OFDM waveform. The preamble signal is followed by the PRDCH without a gap. The PRDCH is followed by the postamble signal without a gap. When the postamble signal ends during an OFDM symbol duration, a padding signal is included from the end of the postamble signal for a remainder of the OFDM symbol duration.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using OFDM according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure;

FIG. 9 illustrates a diagram of an example type-1 backscatter structure for IoT devices according to embodiments of the present disclosure;

FIG. 10 illustrates a diagram of an example impedance matching circuit according to embodiments of the present disclosure;

FIG. 11 illustrates a diagram of an example type-2a backscatter structure for IoT devices according to embodiments of the present disclosure;

FIG. 12 illustrates a diagram of an example type-2a backscatter structure for IoT devices according to embodiments of the present disclosure;

FIG. 13 illustrates a diagram of an example type-2a backscatter structure for IoT devices according to embodiments of the present disclosure;

FIG. 14 illustrates a diagram of an example type-2b active structure for IoT devices according to embodiments of the present disclosure;

FIG. 15 illustrates a diagram of an example type-2b active structure for IoT devices according to embodiments of the present disclosure;

FIG. 16 illustrates a diagram of an example type-2b active structure for IoT devices according to embodiments of the present disclosure;

FIG. 17 illustrates an example system for device to reader (D2R)/reader to device (R2D) transmission involving an intermediate node according to embodiments of the present disclosure;

FIG. 18 illustrates example cyclic prefix (CP)-OFDM symbols according to embodiments of the present disclosure;

FIG. 19 illustrates a flowchart of an example procedure for sending OOK chip data according to embodiments of the present disclosure;

FIG. 20 illustrates example CP-OFDM symbols according to embodiments of the present disclosure;

FIG. 21 illustrates an example transmission according to embodiments of the present disclosure;

FIG. 22 illustrates a flowchart of an example procedure for determining the end of useful information of a received signal;

FIG. 23 illustrates an example signal structure according to embodiments of the present disclosure.

FIG. 24 illustrates example CP-OFDM symbols according to embodiments of the present disclosure;

FIG. 25 illustrates a flowchart of an example procedure for detecting OOK chips according to embodiments of the present disclosure;

FIG. 26 illustrates a flowchart of an example procedure for CP attachment according to embodiments of the present disclosure;

FIG. 27 illustrates examples of CP-OFDM symbols according to embodiments of the present disclosure;

FIG. 28 illustrates an example mapping for frame structure-OFDM symbols according to embodiments of the present disclosure;

FIG. 29 illustrates an example signal architecture according to embodiments of the present disclosure;

FIG. 30 illustrates an example mapping for preamble-OFDM symbols according to embodiments of the present disclosure;

FIG. 31 illustrates an example of CP-OFDM symbols according to embodiments of the present disclosure;

FIG. 32 illustrates an example signal architecture according to embodiments of the present disclosure;

FIG. 33 illustrates an example signal architecture for A-IoT system(s) according to embodiments of the present disclosure;

FIG. 34 illustrates a flowchart of an example procedure for CP removal according to embodiments of the present disclosure;

FIG. 35 illustrates a flowchart of an example procedure for CP removal according to embodiments of the present disclosure;

FIG. 36 illustrates a flowchart of an example procedure for CP removal according to embodiments of the present disclosure;

FIG. 37 illustrates example CP-OFDM symbols according to embodiments of the present disclosure;

FIG. 38 illustrates a timeline of example OOK chip detection according to embodiments of the present disclosure; and

FIG. 39 illustrates a flowchart of example procedure for OOK signal detection according to embodiments of the present disclosure.

### DETAILED DESCRIPTION

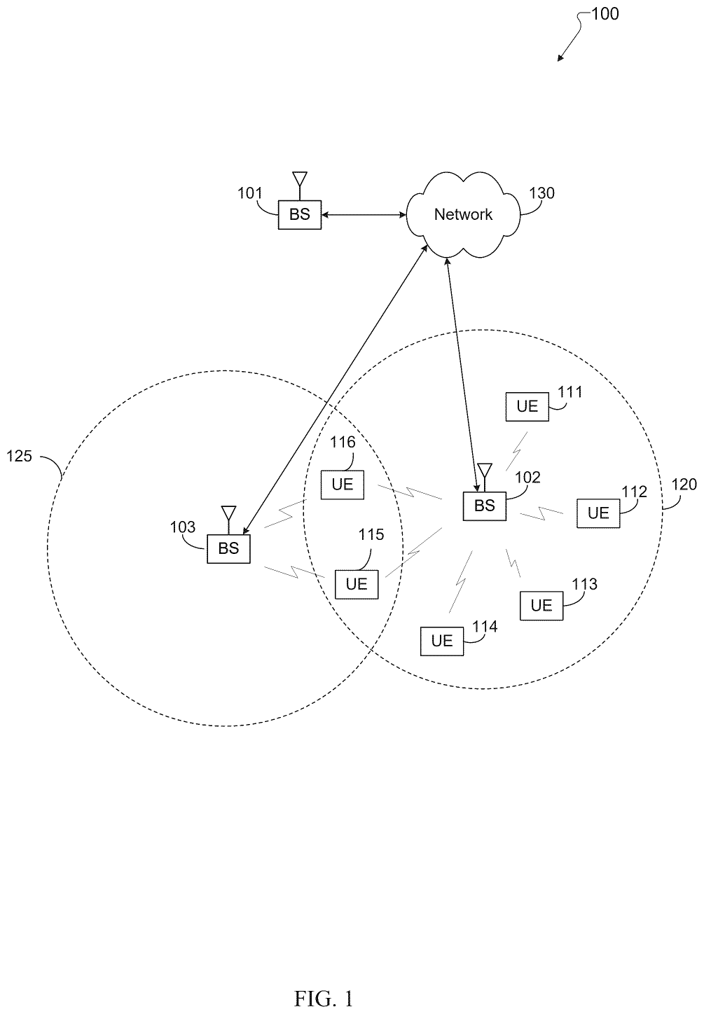

FIGS. 1-39, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1]3GPP TS 38.211 v18.3.0, “NR; Physical channels and modulation;” [REF 2]3GPP TS 38.212 v18.3.0, “NR; Multiplexing and channel coding;” [REF 3]3GPP TS 38.213 v18.3.0, “NR; Physical layer procedures for control;” [REF 4]3GPP TS 38.214 v18.3.0, “NR; Physical layer procedures for data;” [REF 5]3GPP TS 38.331 v18.1.0, “NR; Radio Resource Control (RRC) protocol specification;” and [REF 6]3GPP TS 38.321 v18.1.0, “NR; Medium Access Control (MAC) protocol specification.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting generation of on-off keying signal based on an OFDM waveform. In certain embodiments, one or more of the gNBs 101-103 include circuitry, programing, or a combination thereof to provide for generating an on-off keying signal based on an OFDM waveform.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

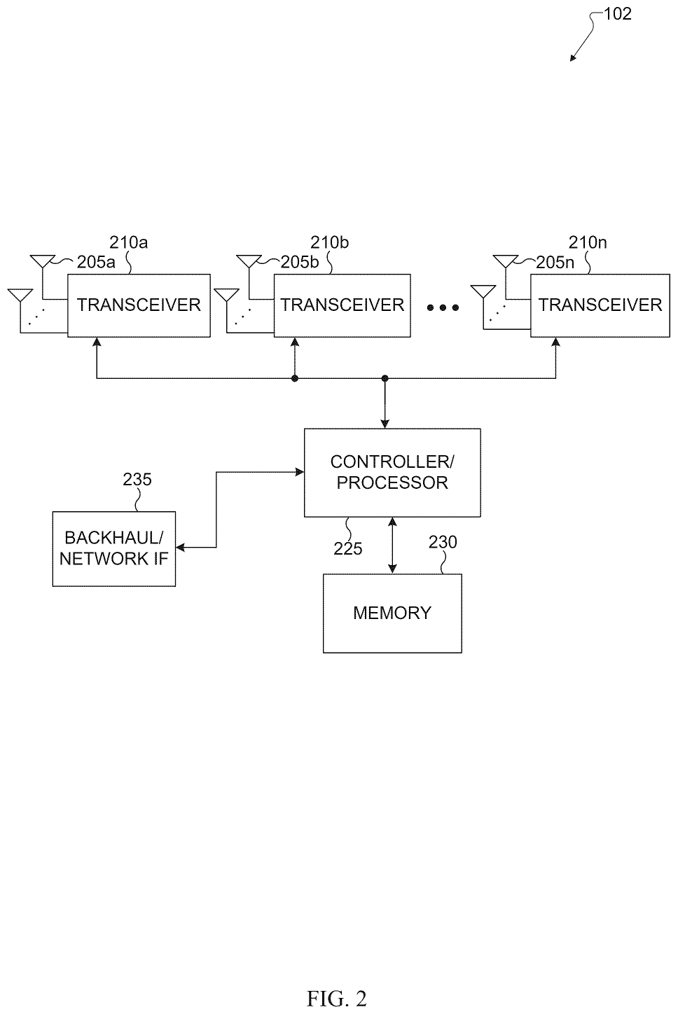

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for generation of an on-off keying signal based on an OFDM waveform. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

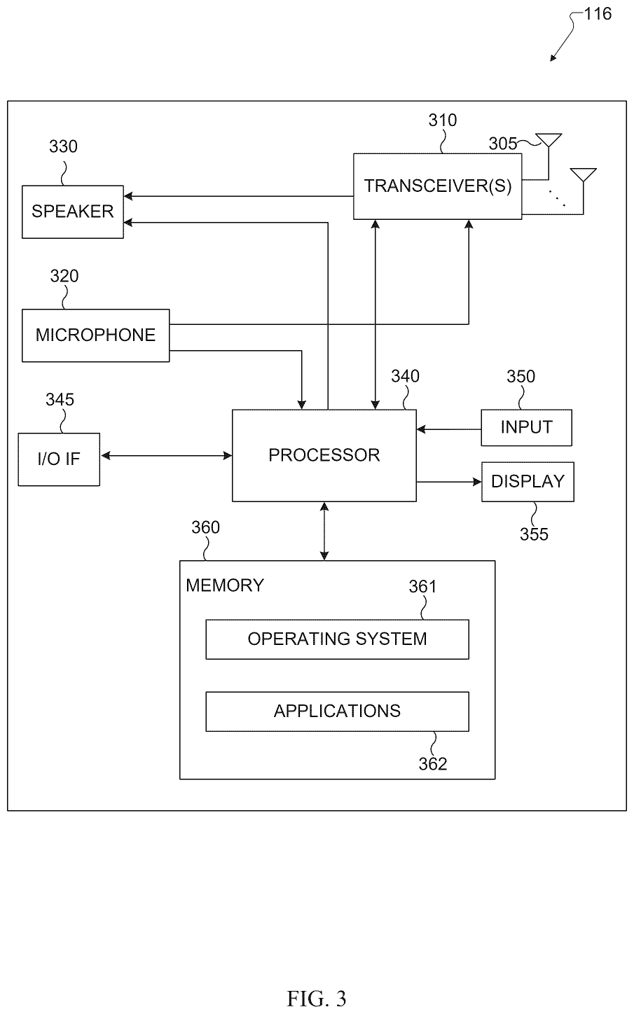

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support generating on-off keying signal based on an OFDM waveform as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

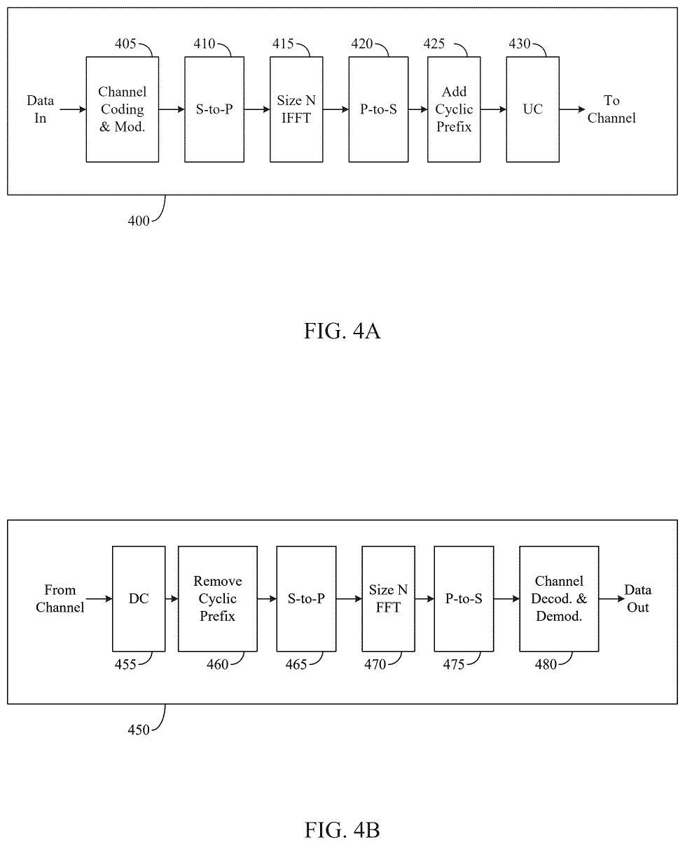

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for generating an on-off keying signal based on an OFDM waveform as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Internet of things (IoT) devices include ambient-power-enabled IoT (A-IoT) devices, which are ultra-low-complexity devices with very small form factor and low-cost design that operate without a common battery that can be manually replaced or recharged. Instead, A-IoT devices can be battery-less or with a small battery (such as a small capacitor) that operate based on energy harvesting from RF waveforms or other ambient energy sources. Regarding the limited size and complexity required by practical applications for battery-less devices with no energy storage capability or devices with limited energy storage that do not need to be replaced or recharged manually, the output power of energy harvester is typically from 1pW to a few hundreds of μW.

In various embodiments throughout the disclosure, a UE (e.g., the UE 116) or a device may be referred to as an A-IoT device or an A-IoT UE based on energy harvesting with ultra-low complexity and power consumption and for low-end IoT applications. For example, the UE may have limited (or no) energy storage or battery capability (e.g., a capacitor), such as an energy storage unit for amplification of receptions at the UE or transmission by the UE, or for other UE operations, such as power-on, warm-up, memory, internal processing, and so on, or operating with backscattering communication.

An A-IoT device can be an IoT device that satisfies one or more of the following (or variations thereof):
powered by energy harvesting, being either battery-less or with limited energy storage capability (e.g., using a capacitor) and the energy is provided through the harvesting of radio waves (including RF waveforms), light (including solar light or indoor light), motion, pressure, heat, or any other power source that could be seen suitable;
with low complexity, small size and lower capabilities and lower power consumption than previously defined 3GPP IoT devices (e.g., NB-IoT/enhanced machine type communication (eMTC) devices);
maintenance free and can have long life span (e.g., more than 10 years).

An A-IoT may directly communicate with a base station/gNB (e.g., the BS 102) (e.g., operating as a reader), or may indirectly communicate with a BS/gNB through an intermediate/assisting node, such as a handheld device/UE (for example, a “reader” UE that scans the A-IoT devices), a relay, integrated access and backhaul (IAB) node, a repeater for example a network-controlled repeater (NCR), and so on. The communication can be mono-static wherein the transmitter node to the A-IoT device is same as the receiving node from the A-IoT device, or can be bi-static (or multi-static) wherein the transmitter nodes to the A-IoT device can be different from the receiving nodes from the A-IoT device.

In various embodiments, the A-IoT device operates with energy storage and power management capability. These devices are characterized by ultra-low power consumption, and they employ energy harvesting mechanisms such as solar, RF energy and kinetic energy and thus don't require battery replacement or swapping frequently. In various embodiments, an A-IoT device operates with energy harvesting (EH) or with limited (or no) energy storage/battery capability (such as a capacitor), such as an energy storage unit for amplification of receptions at the UE (e.g., the UE 116) or transmission by the UE, or for other UE operations, such as power-on, warm-up, memory, internal processing, and so on, or operating with backscattering communication.

In various embodiments, the A-IoT device operates with RF envelope detection for receiving amplitude shift keying (ASK), e.g., OOK, modulated signal. RF envelope detection is a key function that enables the Ambient IoT devices to filter and analyze RF signals. This technique is applied in the reception of modulated RF signals with a view of acquiring information from the signals and hence enable communication between devices with efficiency and with minimum power consumption. RF envelope detection is one of the most important techniques that are used in many of the low power consumption wireless communication protocols that are employed in Ambient IoT systems.

In various embodiments, the A-IoT device may operate with impedance matching.

Impedance matching may be utilized in passive Ambient IoT devices backscattering externally provisioned carrier wave (CW) signal.

The disclosure relates to defining functionalities and procedures for A-IoT devices to generate an on-off keying signal based on an OFDM waveform. DL and UL are also referred to as reader-to-device (R2D) and device-to-reader (D2R), respectively, and vice versa.

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

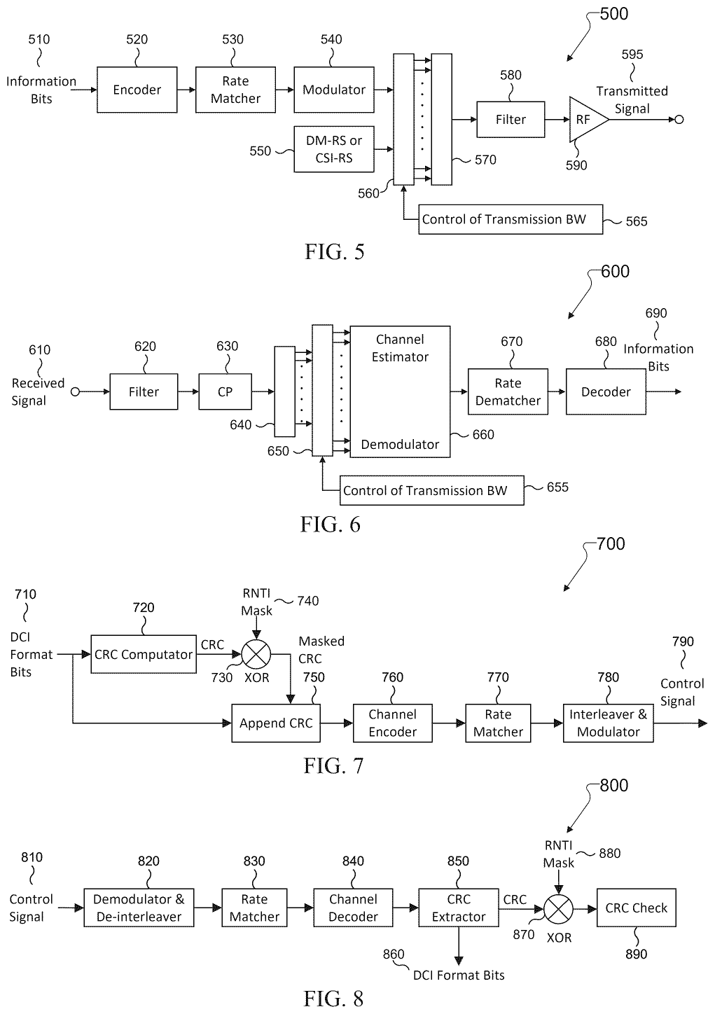

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 24 bits and the RNTI can include 16 bits or 24 bits. The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1) =0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

It is envisaged that the number of connected devices will reach 18 500 billion by 2030, which is about ˜59 times larger than the expected world population (˜8.5 billion) by that time. Mobile devices will take various form-factors, such as augmented reality (AR) glasses, virtual reality (VR) headsets, hologram devices, while a large portion of the devices will be Internet-of-Things (IoT) devices for improving productivity efficiency and increasing comforts of life. As the number of IoT devices grows exponentially, those IoT devices will become dominant in the next generation wireless communication systems such as fifth generation (5G) advanced, sixth generation (6G) systems, and so on.

With the explosive number of IoT devices, it may be challenging to power the IoT devices by battery that needs to be replaced or recharged manually, which leads to high maintenance cost. The automation and digitalization of various industries demand new IoT technologies of supporting batteryless devices with no energy storage capability or devices with energy storage that does not need to be replaced or recharged manually. Such types of devices are collectively termed as ambient IoT (A-IoT) in this disclosure, which is powered by various renewable energy sources such as radio waves, light, motion, or heat, etc. Use cases of A-IoT devices include asset inventory/tracking and remote environmental monitoring. The following list provides example use cases of A-IoT devices:
Indoor inventory
   Automated warehousing
   Medical instruments inventory management and positioning
   Non-Public Network for logistics
   Automobile manufacturing
   Airport terminal/shipping port
   Smart laundry
   Automated supply chain distribution
   Fresh food supply chain
   End-to-end logistics
   Flower auction
   Electronic shelf label
Indoor sensor
   Smart homes
   Base station machine room environmental supervision
   Smart laundry
   Smart agriculture
   Smart pig farm
   Cow stable
Indoor positioning
   Finding Remote Lost Item
   Location service
   Ranging in a home
   Personal belongings finding
   Positioning in shopping centre
   Museum Guide
Indoor command
   Online modification of medical instruments status
   Device activation and deactivation
   Elderly Health Care
   Device Permanent Deactivation
   Electronic shelf label
Outdoor inventory
   Medical instruments inventory management and positioning
   Non-public network for logistics
   Airport terminal/shipping port
   Automated supply chain distribution
Outdoor sensor
   Smart grids
   Forest Fire Monitoring
   Dairy farming
   Smart manhole cover safety monitoring
   Smart bridge health monitoring
Outdoor positioning
   Finding remote lost item
   Location service
   Personal belongings finding
Outdoor command
   Online modification of medical instruments status
   Device activation and deactivation
   Elderly Health Care
   Controller in smart agriculture

Taking into account the limited size and low complexity required by practical applications of A-IoT devices, the output power of energy harvesting from ambient power sources is typically from 1μW to a few hundreds of μW, which is orders of magnitude lower than normal user equipment (UE) having peak power consumption higher than 10 mW. This requires a new wireless access technology for A-IoT devices, which cannot be fulfilled by existing cellular systems including low-power IoT technologies such as NB-IoT and eMTC.

In the following, an italicized name for a parameter implies that the parameter is provided by higher layers.

DL (e.g., physical reader to device (R2D) channel (PRDCH)) transmissions or UL (e.g., PDRCH) transmissions can be based on an OFDM waveform including a variant using DFT precoding that is known as DFT-spread-OFDM that is typically applicable to UL transmissions.

In the following, subframe (SF) refers to a transmission time unit for the LTE RAT and slot refers to a transmission time unit for an NR RAT. For example, the slot duration can be a sub-multiple of the SF duration. NR can use a different DL or UL slot structure than an LTE SF structure. Differences can include a structure for transmitting physical downlink control channels (PDCCHs), locations and structure of demodulation reference signals (DM-RS), transmission duration, and so on. Further, eNB refers to a base station serving UEs operating with LTE RAT and gNB refers to a base station serving UEs operating with NR RAT. Exemplary embodiments provide a same numerology, that includes a sub-carrier spacing (SCS) configuration and a cyclic prefix (CP) length for an OFDM symbol, for transmission with LTE RAT and with NR RAT. In such case, OFDM symbols for the LTE RAT as same as for the NR RAT, a subframe is same as a slot and, for brevity, the term slot is subsequently used in the remaining of the disclosure.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration y as 2¹ ” 15 kHz. A unit of one sub-carrier over one symbol is referred to as resource element (RE). A unit of one RB over one symbol is referred to as physical RB (PRB).

DL signaling include physical downlink shared channels (PDSCHs) conveying information content, PDCCHs conveying DL control information (DCI), and reference signals (RS). A PDCCH can be transmitted over a variable number of slot symbols including one slot symbol and over a number of control channel elements (CCEs) from a predetermined set of numbers of CCEs referred to as CCE aggregation level within a control resource set (CORESET) as described in v17.6.0 of [REF 1] and v17.6.0 of [REF 3].

For OFDM baseband signal generation for channels except physical random access channel (PRACH) and remote interference management reference signa (RIM-RS), the time-continuous signal

$${s}_{l}^{( p , μ )} ( t )$$

on antenna port p and subcarrier spacing configuration μ for OFDM symbol

$$1 \\ l ∈ \{ 0 , 1 , … , {N}_{slot}^{subframe , μ} {N}_{symb}^{slot} - 1 \}$$

in a subframe for any physical channel or signal except PRACH is defined by

$$\begin{matrix}{s}_{l}^{( p , μ )} ( t ) = \{ \begin{matrix}{\overline{s}}_{l}^{( p , μ )} & {t}_{start , l}^{μ} \leq t < {t}_{start , l}^{μ} + {T}_{start , l}^{μ} \\ 0 & otherwise\end{matrix} \\ {\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{π} - {N}_{grid , x}^{size , μ} {N}_{sc}^{RB} / 2 ) Δ f ( t - {N}_{CP , l}^{μ} {T}_{c} - {t}_{start , l}^{μ} )} \\ {k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ} \\ {T}_{symb , l}^{μ} = ( {N}_{u}^{μ} + {N}_{CP , l}^{μ} ) {T}_{c}\end{matrix}$$

where t=0 at the start of the subframe,

$$\begin{matrix}{N}_{u}^{μ} = 2048 κ \cdot {2}^{- μ} \\ {N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {22}^{- μ} & normal cyclic prefix , l \neq 0 or l \neq 7 \cdot {2}^{μ}\end{matrix}\end{matrix}$$

and
Δf is given by clause 4.2 of [REF 1];
μ is the subcarrier spacing configuration;
μ₀ is the largest y value among the subcarrier spacing configurations by scs-SpecifpcCarrierList for each of uplink and downlink and by sl-SCS-SpecificCarrierList for sidelink.

In case of cyclic prefix extension of the first OFDM symbol l allocated for physical uplink shared channel (PUSCH), sounding reference signal (SRS), or physical uplink control channel (PUCCH) transmission, the time-continuous signal

$${s}_{ext}^{( p , μ )} ( t )$$

for the interval

$$\begin{matrix}{t}_{start , l}^{μ} - \\ {T}_{ext} \leq t < {t}_{start , l}^{μ}\end{matrix}$$

preceding the first OFDM symbol for PUSCH, SRS, or PUCCH is given by

$${s}_{ext}^{( p , μ )} ( t ) = {\overline{s}}_{l}^{( p , μ )} ( t )$$

where t<0 refers to the signal in the previous subframe and
for dynamically scheduled PUSCH, SRS, and PUCCH transmissions

$$\begin{matrix}{T}_{ext} = min ( max ( {T}_{ext}^{′} , 0 ) , {T}_{symb , ( l - 1 ) mod 7 \cdot {2}^{μ}}^{μ} ) \\ {T}_{ext}^{′} = {\sum }_{k = 1}^{{c}_{i}} {T}_{symb , ( l - k ) mod 7 \cdot {2}^{μ}}^{μ} - {Δ}_{i}\end{matrix}$$

where Δᵢ is given by Table 5.3.1-1 with C₁=1 for μ∈{0,1}, C₁=2 for μ=2, and C₂ and C₃ given by the higher-layer parameters cp-ExtensionC2 and cp-ExtensionC3, respectively, and T_{TA} given by clause 4.3.1. For contention-based random access, or in absence of higher-layer configuration of C₂ and C₃, the value of Cᵢshall be set to the largest integer fulfilling

$$\begin{matrix}{T}_{ext}^{′} < \\ {T}_{symb , ( l - k ) mod 7 \cdot {2}^{μ}}^{μ}\end{matrix}$$

for each of the values of i∈{2,3}. Txt is applied to the first UL transmission scheduled by the scheduling DCI.
for a PUSCH transmission using configured grant

$${T}_{ext} = {\sum }_{k = 1}^{{2}^{μ}} {T}_{symb , ( l - k ) mod 7 \cdot {2}^{μ}}^{μ} - {Δ}_{i}$$

where Δᵢ is given by Table 5.3.1-2 with the index i given by the procedure in [REF 4].

The starting position of OFDM symbol l for subcarrier spacing configuration yin a subframe is given by

$${t}_{start , l}^{μ} = \{ \begin{matrix}0 & l = 0 \\ {t}_{start , l}^{μ} + ( {N}_{u}^{μ} + {N}_{CP , l - 1}^{μ} ) \cdot {T}_{c} & otherwise\end{matrix}$$

DCI can serve several purposes. A DCI format includes a number of fields, or information elements (IEs), and is typically used for scheduling a PDSCH (DL DCI format) or a PUSCH (UL DCI format) transmission. A DCI format includes cyclic redundancy check (CRC) bits in order for a UE (e.g., the UE 116) to confirm a correct detection. A DCI format type is identified by a radio network temporary identifier (RNTI) that scrambles the CRC bits. For a DCI format scheduling a physical downlink shared channel (PDSCH) or a PUSCH for a single UE with RRC connection to a gNB (e.g., the BS 102), the RNTI is a cell RNTI (C-RNTI) or another RNTI type such as a modulation and coding scheme-cell RNTI (MCS-C-RNTI). For a DCI format scheduling a PDSCH conveying system information (SI) to a group of UEs, the RNTI is a system information RNTI (SI-RNTI). For a DCI format scheduling a PDSCH providing a response to a random access (RA) from a group of UEs, the RNTI is a random access (RA-RNTI). For a DCI format scheduling a PDSCH providing contention resolution in Msg4 of a RA process, the RNTI is a temporary C-RNTI (TC-RNTI). For a DCI format scheduling a PDSCH paging a group of UEs, the RNTI is a paging RNTI (P-RNTI). For a DCI format providing transmission power control (TPC) commands to a group of UEs, the RNTI is a transmit power control radio network temporary identifier (TPC-RNTI), and so on. Each RNTI type is configured to a UE through higher layer signaling. A UE typically decodes at multiple candidate locations for PDCCH receptions as determined by an associated search space set.

For each DL bandwidth part (BWP) indicated to a UE in a serving cell, the UE can be provided by higher layer signaling with P; 3 control resource sets (CORESETs). For each CORESET, the UE is provided a CORESET index p, 0<p<12, a DM-RS scrambling sequence initialization value, a precoder granularity for a number of resource element groups (REGs) in the frequency domain where the UE can expect use of a same DM-RS precoder, a number of consecutive symbols for the CORESET, a set of resource blocks (RBs) for the CORESET, control channel element to resource element group (CCE-to-REG) mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of T_{S}≤kₛ slots indicating a number of slots that the search space set s exists, a number of PDCCH candidates Mₛ^{(L)} per CCE aggregation level L, and an indication that search space set s is either a common search space (CSS) set or a UE-specific search space (USS) set. When search space set s is a CSS set, the UE monitors PDCCH for detection of DCI format 2_x, where x ranges from 0 to 7 as described in v17.6.0 of [REF2]or for DCI formats associated with scheduling broadcast/multicast PDSCH receptions, and for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number

$${n}_{s , f}^{μ}$$

in a frame with number

$${n}_{f} if ( {n}_{f} \cdot {N}_{slot}^{frame , μ} + {n}_{s , f}^{μ} - {o}_{s} ) mod {k}_{s} = 0.$$

The UE monitors PDCCH candidates for search space set s for Tₛ consecutive slots, starting from slot

$${n}_{s , f}^{μ} ,$$

and does not monitor PDCCH candidates for search space set s for the next kₛ- Tₛ consecutive slots. The UE determines CCEs for monitoring PDCCH according to a search space set based on a search space equation as described in [REF3].

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes will be referred to as DCI size limit. When the DCI size limit would be exceeded for a UE based on a configuration of DCI formats that the UE monitors PDCCH, the UE aligns the size of some DCI formats, as described in v17.6.0 of [REF2], so that the DCI size limit would not be exceeded.

For each scheduled cell, the UE is not required to monitor on the active DL BWP with SCS configuration μ of the scheduling cell more than

$$min ( {M}_{PDCCH}^{max , slot , μ} , {M}_{PDCCH}^{total , slot , μ} )$$

PDCCH candidates or more than

$$min ( {C}_{PDCCH}^{max , slot , μ} , {C}_{PDCCH}^{total , slot , μ} )$$

non-overlapped CCEs per slot wherein

$${M}_{PDCCH}^{max , slot , μ} and {C}_{PDCCH}^{max , slot , μ}$$

are respectively a maximum number of PDCCH candidates and non-overlapping CCEs for a scheduled cell and

$${M}_{PDCCH}^{total , slot , μ} and {C}_{PDCCH}^{total , slot , μ}$$

are respectively a total number of PDCCH candidates and non-overlapping CCEs for a scheduling cell, as described in [REF3].

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot would exceed the limits/maximum per slot for scheduling on the primary cell mentioned herein, the UE selects the USS sets or the CSS sets to monitor corresponding PDCCH in an ascending order of a corresponding search space set index until and an index of a search space set for which PDCCH monitoring would result to exceeding the maximum number of PDCCH candidates or non-overlapping CCEs per slot for scheduling on the PCell as described in [REF3].

For same cell scheduling or for cross-carrier scheduling where a scheduling cell and scheduled cells have DL BWPs with same SCS configuration y, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in v17.6.0 of [REF3]and [REF4].

MIMO technologies have a key role in boosting system throughput both in NR and LTE and such a role will continue and further expand in the future generations of wireless technologies. For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

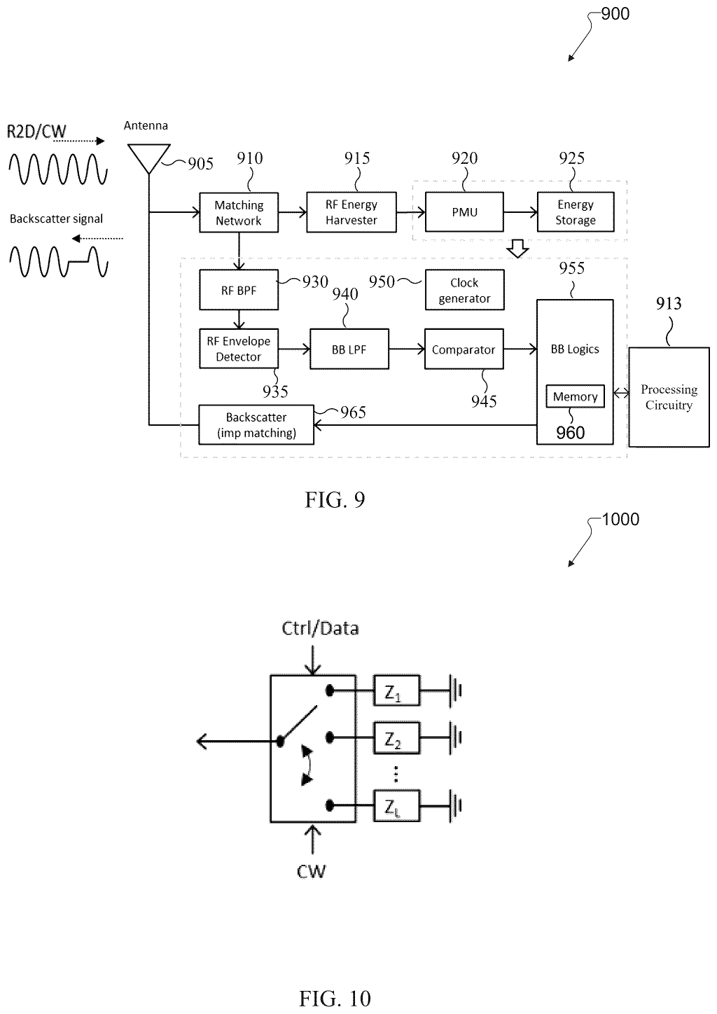

FIG. 9 illustrates a diagram of an example type-1 backscatter structure 900 for IoT devices according to embodiments of the present disclosure. For example, type-1 backscatter structure 900 can be implemented by any of the UEs 111-116 of FIG. 1, or may be devices with fewer components and functionality than a UE. This example is for illustration only and other embodiments can be used without departing from the scope of the present disclosure.

As shown in FIG. 9, the type-1 backscatter structure 900 for IoT devices includes an antenna 905, a matching network 910, a RF energy harvester 915, a power management unit (PMU) 920, an energy storage 925, a RF bandpass filter (BPF) 930, a RF envelope detector 935, a baseband (BB) lowpass filter (LPF) 940, a comparator 945, a clock generator 950, a BB logistics 955, a memory 960, backscatter (imp matching) 965, and processing circuitry 913.

In various embodiments, the processing circuitry 913, which may be a full-powered processor, such as included in UE 116, a lower-power microprocessor or microcontroller, an application specific integrated circuit (ASIC), or logic circuitry. The processing circuitry 913 can control the overall operation of the IoT device including determination of reception and/or transmission timing. The processing circuitry 913 may be powered via energy storage 925. The signal receiving and transmitting processing circuitry included in the IoT devices, such as RF BPF 930, a RF envelope detector 935, a BB LPF 940, a comparator 945, a clock generator 950, a BB logistics 955, a memory 960, and a backscatter (impedance matching) 965, may be referred to as a transceiver, which may use separate antennas for reception and transmission, respectively, or may use a common antenna, such as antenna 905 for transmission and reception. One or more implementations described herein further include other implementation variations such as separate Tx-Rx antennas vs common Tx-Rx antenna, use of a sensor, etc. The implementations should be understood as an example and not as a restriction.

FIG. 10 illustrates a diagram of an example impedance matching circuit according to embodiments of the present disclosure. For example, impedance matching circuit 1000 can be implemented in any of the IoT device described herein. This example is for illustration only and other embodiments can be used without departing from the scope of the present disclosure.

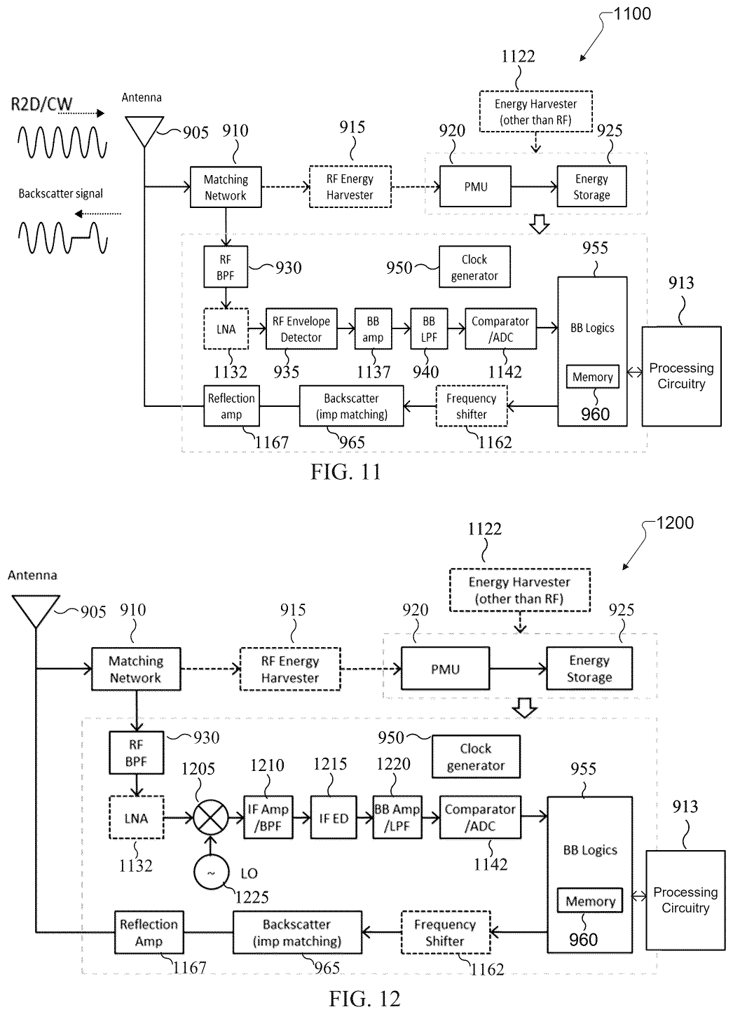

FIG. 11 illustrates a diagram of an example type-2a backscatter structure 1100 for IoT devices according to embodiments of the present disclosure. For example, backscatter structure 1100 can be implemented by any of the UEs 111-116 of FIG. 1, such as the UE 111, or may be devices with fewer components and functionality than a UE. This example is for illustration only and other embodiments can be used without departing from the scope of the present disclosure.

As shown in FIG. 11, the type-2a backscatter structure 1100 includes an antenna 905, a matching network 910, a RF energy harvester 915, a PMU 920, an energy storage 925, an energy harvester (other than RF) 1122, a RF BPF 930, a low noise amplifier (LNA) 1132, a RF envelope detector 935, a BB amp 1137, a BB LPF 940, a comparator/ADC 1142, a clock generator 950, a BB logistics 955, a memory 960, a frequency shifter 1162, backscatter (imp matching) 965, a reflection amp 1167, and processing circuitry 913.

FIG. 12 illustrates a diagram of an example type-2a backscatter structure 1200 for IoT devices according to embodiments of the present disclosure. For example, backscatter structure 1200 can be implemented by any of the UEs 111-116 of FIG. 1, such as the UE 112, or may be devices with fewer components and functionality than a UE. This example is for illustration only and other embodiments can be used without departing from the scope of the present disclosure.

As shown in FIG. 12, the type-2a backscatter structure 1200 includes an antenna 905, a matching network 910, a RF energy harvester 915, a PMU 920, an energy storage 925, an energy harvester (other than RF) 1122, a RF BPF 930, a LNA 1132, a mixer 1205, a LO 1225, a IF amp/BPF 1210, an IF ED 1215, a BB Amp/LPF 1220, a comparator/ADC 1142, a clock generator 950, a BB logistics 955, a memory 960, a frequency shifter 1162, a backscatter (impedance Matching) 965, reflection amp 1167, and processing circuitry 913.

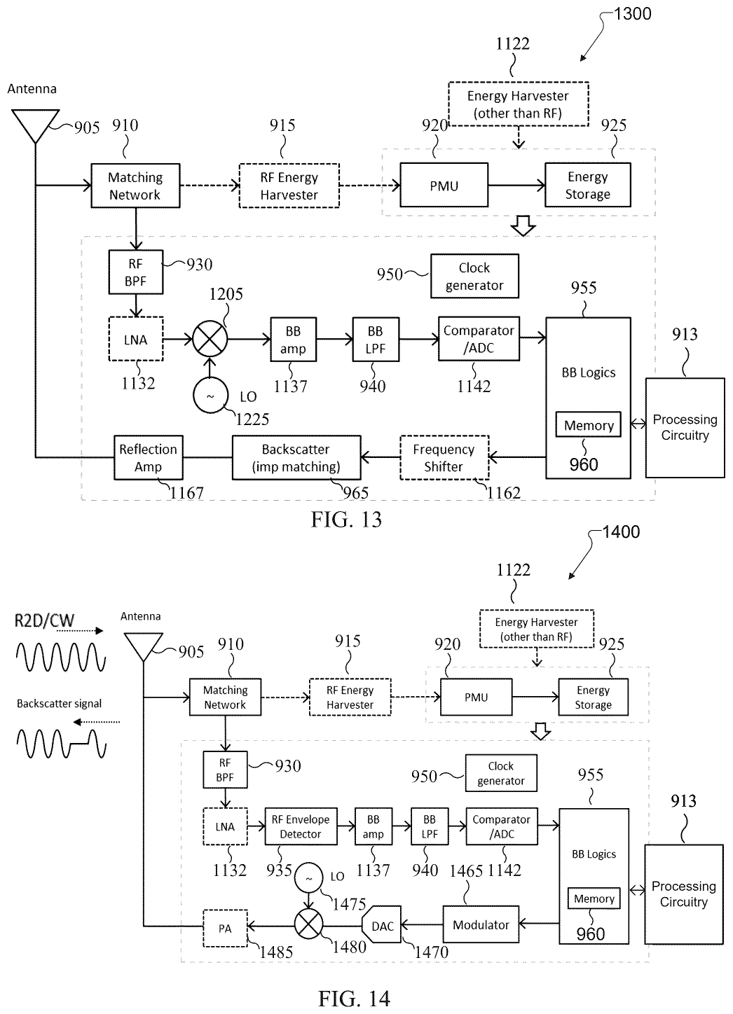

FIG. 13 illustrates a diagram of an example type-2a backscatter structure 1300 for IoT devices according to embodiments of the present disclosure. For example, structure 1300 can be implemented by any of the UEs 111-116 of FIG. 1, such as the UE 113, or may be devices with fewer components and functionality than a UE. This example is for illustration only and other embodiments can be used without departing from the scope of the present disclosure.

As shown in FIG. 13, the type-2a backscatter structure 1300 includes an antenna 905, a matching network 910, a RF energy harvester 915, a PMU 920, an energy storage 925, an energy harvester (other than RF) 1122, a RF BPF 930, a LNA 1132, a mixer 1205, an LO 1225, a BB amplifier 1137, a BB LPF 940, a comparator/ADC 1142, a clock generator 950, a BB logistics 955, a memory 960, a frequency shifter 1162, a backscatter (impedance matching) 965, a reflection amp 1167, and processing circuitry 913.

FIG. 14 illustrates a diagram of an example type-2b active structure 1400 for IoT devices according to embodiments of the present disclosure. For example, backscatter structure 1400 can be implemented by any of the UEs 111-116 of FIG. 1, such as the UE 114, or may be devices with fewer components and functionality than a UE. This example is for illustration only and other embodiments can be used without departing from the scope of the present disclosure.

As shown in FIG. 14, the type-2b active structure 1400 includes an antenna 905, a matching network 910, a RF energy harvester 915, a PMU 920, an energy storage 925, an energy harvester (other than RF) 1122, a RF BPF 930, a LNA 1132, a RF envelope detector 935, a BB amp 1137, a BB LPF 940, a comparator/ADC 1142, a clock generator 950, a BB logistics 955, a memory 960, a modulator 1465, a digital to analog converter (DAC) 1470, a LO 1475, a mixer 1480, a PA 1485, and processing circuitry 913.

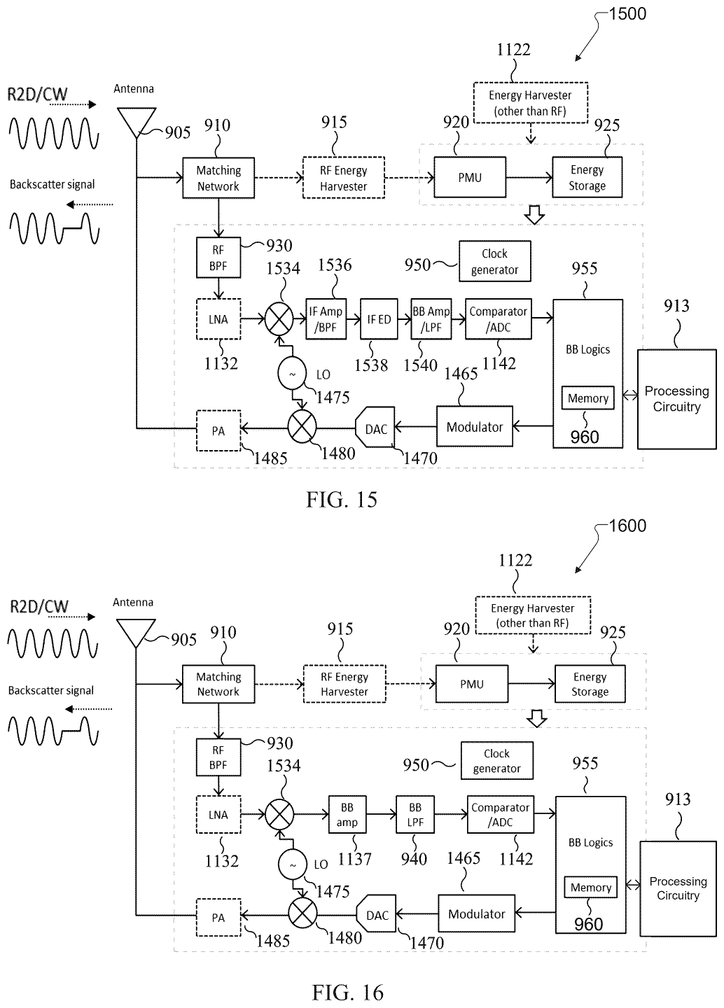

FIG. 15 illustrates a diagram of an example type-2b active structure 1500 for IoT devices according to embodiments of the present disclosure. For example, structure 1500 can be implemented by any of the UEs 111-116 of FIG. 1, such as the UE 115, or may be devices with fewer components and functionality than a UE. This example is for illustration only and other embodiments can be used without departing from the scope of the present disclosure.

As shown in FIG. 15, the structure 1500 includes an antenna 905, a matching network 910, a RF energy harvester 915, a PMU 920, an energy storage 925, an energy harvester (other than RF) 1122, a RF BPF 930, a LNA 1132, a mixer 1534, an IF amp/BPF 1536, an IF ED 1538, a BB amp/LPF 1540, a comparator/ADC 1142, a clock generator 950, a BB logistics 955, a memory 960, a modulator 1465, a DAC 1470, a LO 1475, a mixer 1480, a PA 1485, and processing circuitry 913.

FIG. 16 illustrates a diagram of an example type-2b active structure 1600 for IoT devices according to embodiments of the present disclosure. For example, structure 1600 can be implemented by any of the UEs 111-116 of FIG. 1, such as the UE 116, or may be devices with fewer components and functionality than a UE. This example is for illustration only and other embodiments can be used without departing from the scope of the present disclosure.

As shown in FIG. 16, the structure 1600 includes an antenna 905, a matching network 910, a RF energy harvester 915, a PMU 920, an energy storage 925, an energy harvester (other than RF) 1122, a RF BPF 930, a LNA 1132, a mixer 1534, a BB amp 1137, a BB LPF 940, a comparator/ADC 1142, a clock generator 950, a BB logistics 955, a memory 960, a modulator 1465, a DAC 1470, a LO 1475, a mixer 1480, a PA 1285, and processing circuitry 913.

Several different types of A-IoT devices can be regarded as following.
Device 1: ˜1 μW peak power consumption, has energy storage, initial sampling frequency offset (SFO) up to 10X ppm, neither R2D nor D2R amplification in the device. The device's D2R transmission is backscattered on a carrier wave provided externally.
Device 2a: ≤a few hundred μW peak power consumption, has energy storage, initial sampling frequency offset (SFO) up to 10X ppm, both R2D and/or D2R amplification in the device. The device's D2R transmission is backscattered on a carrier wave provided externally.
Device 2b: <a few hundred μW peak power consumption, has energy storage, initial sampling frequency offset (SFO) up to 10X ppm, both R2D and/or D2R amplification in the device. The device's D2R transmission is generated internally by the device.

The devices may operate in frequency division duplexing (FDD) spectrum or time division duplexing (TDD) spectrum, which may be licensed or unlicensed.

In the following, reference architectures for the device types herein are provided, which should be understood as an example and not as a restriction.

With reference to FIG. 9, an example Type-1 backscatter device structure according to the disclosure is shown.

The RF energy harvester 915 converts RF signal to DC power and supplies the device. Either a R2D signal or an externally provisioned CW signal for backscattering can be utilized for RF energy harvesting. The CW is externally provided from a gNB or a dedicated source. The source of CW signal, e.g., either a gNB or a dedicated node, may or may not be agnostic to A-IoT devices. The harvested energy, e.g., using a rectifier, can be stored using a capacitor, super-capacitor, or, generally speaking, an energy storage. Antenna could be either shared or separate for RF energy harvester and receiver/transmitter. Matching network 910 is to match impedance between antenna and other components. Power management unit (PMU) 920 manages storing energy to energy storage from energy harvester and supplying power to active component blocks which needs power supply. Clock generator 950 provides required clock signal(s).

The R2D signal is demodulated using a low complexity envelope detector and comparator, whose output is provided as an input to the baseband circuit. Given the low-power and low-complexity requirements of the Type-1 backscatter device, an RF envelope detection can be a viable solution for a receiver architecture, compared to a heterodyne architecture with IF envelope detection or a homodyne architecture with baseband envelope detection, which require LO and frequency mixer for frequency down-conversion. The input RF signal passes through an RF band-pass filter (BPF) 930 for an adjacent channel interference suppression, and then the filtered RF signal is directly converted into a baseband using an RF envelope detector 935, followed by a baseband low-pass filter (LPF) 940 for filtering out harmonics and high frequency components, and an n-bit comparator, where n can be 1, 2, 4, 8, . . . The use of filters, e.g., BPF 930 only, LPF 940 only, or both, can be an implementation choice.

For the D2R backscatter transmission, any of the following can be used:
Case 1) CW is provisioned at DL spectrum and backscattered, i.e., CW @DL spectrum, D2R backscattering @DL spectrum.
Case 2) CW is provisioned at UL spectrum and backscattered, i.e., CW @UL spectrum, D2R backscattering @UL spectrum.
Case 3) CW is provisioned at DL spectrum, frequency shifted to UL spectrum, and then backscattered, i.e., CW @DL spectrum, D2R backscattering @UL spectrum.

In one example, Case 1) or Case 2) is evaluated for device 1, i.e., CW and D2R backscattering on the same frequency and, therefore, a frequency shifter (FS) is not required.

With reference to FIG. 10, an example impedance matching circuit for backscatter device D2R modulation according to the disclosure is shown.

The followings are simple examples of impedance matching operations:
Open circuit: Full reflection of the received CW signal in the same phase. This can be used for OOK modulation with matching circuit.
Short circuit: Full reflection of the received CW signal in the reversed phase. This can be used for phase-shift keying (PSK) modulation.
Matching circuit: No reflection as the impedance is matched to a load, i.e., absorption. This can be utilized for energy harvesting, Rx mode, or modulation with other matching states.
Multi-level matching circuit: As illustrated in FIG. 10. Multi-level impedance matching to Z₁, Z₂, . . . , Z_{L} for log₂(L) bits per symbol ASK modulation.

Depending on the matched load impedance, the matching circuit can backscatter the incoming CW signal with different reflection coefficients in both amplitude and phase. In general, amplitude shift keying (ASK)/phase shift keying (PSK)/frequency shift keying (FSK) may be supported using an impedance matching circuit. As a simplest modulation scheme, OOK may be evaluated. The device may indicate its modulation capability or impedance matching capability to the network (e.g., the network 130), or certain requirement may be predefined in the specification of system operation.

With reference to FIG. 11, an example device 2a backscatter architecture based on RF envelope detection according to the disclosure is shown.

The device 2a may share similar structure at large with device 1 as the D2R transmission is still based on backscattering of an externally provided CW, while the device 2a may differ from device 1 from the following aspects.

The device 2a has ≤a few hundred μW peak power consumption and both R2D and/or D2R amplification in the device. In this case, alternative to the RF energy harvesting from a R2D signal or an externally provided CW signal, other renewable energy sources, e.g., solar, thermal, kinetic, etc., may be provided for energy harvesting. The presence of a certain energy harvesting capability from a certain renewable energy source may be expected for system design point of view. The use of energy harvesters, e.g., RF energy harvester 915 only, other energy harvester only, or both, can be an implementation choice.

The device 2a may be equipped with both R2D and/or D2R amplification in the device. Given the power consumption requirement, i.e., ≤a few hundred μW, the R2D/D2R amplification for device 2a may be based on an architecture that is different from the typical power amplifier (PA) and low noise amplifier (LNA). In some example low-power/complexity architectures for forward amplifier for reader-to-device (R2D) reception and reflection amplifier for device-to-reader (D2R) transmission, a single bipolar transistor terminated with microstrips may be used. The receiver amplification can be either RF amplification prior to the envelope detector, baseband amplification after the envelope detector, or both, which is an implementation choice. In one example, a reflection amplifier is used for both R2D reception and D2R transmission, and LNA may or may not exist. In another example, a reflection amplifier is used for D2R transmission only and LNA is used for R2D reception amplification.

In one example, a reflection amplifier can be used only for backscattering, i.e., one-way amplification. In another example, a reflection amplifier can be used for both backscattering and receiving, i.e., two-way amplification. For a reflection amplifier, it can be expected that 10 25 dB gain is achievable, at a power consumption of a few tens to hundreds micro-Watts. It is noted that an exact power consumption value will be highly dependent on implementations. On the other hand, a stability of an amplifier is a function of an input impedance and operating frequency. Since A-IoT devices are expected to be deployed for a certain operating frequency and not expected to adapt to another frequency after deployment, the implementation can ensure a stable operation of the amplifier for the target frequency.

One additional difference of device 2a compared to device 1 may be a use of a FS. With a few hundred μW peak power consumption, some low-power LO architectures with a frequency mixer can be taken into account for Case 3). With FS, it can be expected that the CW is provided in a frequency different than the UL carrier frequency. Because the A-IoT devices are targeting for low complexity and low power consumption, the following options can be evaluated as an example method for frequency shift:
Ultra-low power local oscillator (LO), whose output frequency is multiplied in one or more stages using a frequency multiplier to obtain a desired amount of frequency shift.
Calibrated RC (resistor-capacitor) oscillator, which uses CW frequency as an input to the RC oscillator with phase locked loop (PLL) circuitry.
CW signal provided at the UL carrier frequency; In this case, no frequency shifter is needed.
Use of harmonic frequencies of CW signal or intermodulation frequencies of two-tone CW signals.

The device 2a receiver architecture may be based on RF envelope detector, intermediate frequency (IF) envelope detector (ED), i.e., heterodyne receiver, or homodyne receiver with zero IF, as exemplified for device 2b.

The device 2b shares similar structure at large with the device 2a other than the UL signal is internally generated using LO rather than backscattering the externally provided CW. The example architecture shown in FIGS. 14-16 is based on an active transmitter chain, wherein the UL data is modulated, converted to an analog signal using digital to analog converter (DAC) and, then up-converted to a UL carrier frequency using LO and frequency mixer, which is followed by an amplifier.

In FIG. 14, the DL receiver chain is still based on the RF envelope detector as in the previous architectures. In FIG. 15, the DL receiver chain is based on heterodyne receiver with IF envelope detector. In the heterodyne architecture, the RF signal is down converted into an intermediate frequency and then detected using an envelope detector. In FIG. 16, the DL receiver is based on homodyne receiver, i.e., zero-IF. In the homodyne/zero-IF architecture, the RF signal is directly down converted into baseband signal and then detected using a comparator/ADC.

FIGS. 9-16 should be understood for illustration purpose only. There can be other components not explicitly shown in the figure such as switch, duplexer, and filters, or some components may be replaced to different options. Also, the devices can operate both in TDD and FDD spectrum, either licensed or unlicensed, and, depending on the operating spectrum, the actual architectures can be different from the conceptual illustrations in the figures.

In deploying A-IoT devices, different topology options can be evaluated. The following provides examples of topology options:
Topology 1: BS⇄A-IoT device
An A-IoT device directly and bidirectionally communicates with a basestation. The communication between the basestation and the A-IoT device includes A-IoT data and/or signalling. This topology includes the BS transmitting to the A-IoT device is different from the BS receiving from the A-IoT device.
Topology 2: BS⇄intermediate node ⇄Ambient IoT device
An A-IoT device communicates bidirectionally with an intermediate node between the device and basestation. In this topology, the intermediate node can be a relay, IAB node, UE, repeater, etc. which is capable of A-IoT. The intermediate node transfers A-IoT data and/or signalling between BS and the A-IoT device. The intermediate node is referred to as I-node in this disclosure.
Topology 3: BS⇄assisting node ⇄Ambient IoT device ⇄BS
An A-IoT device transmits data/signalling to a basestation, and receives data/signalling from the assisting node; or the A-IoT device receives data/signalling from a basestation and transmits data/signalling to the assisting node. In this topology, the assisting node can be a relay, IAB, UE, repeater, etc. which is capable of A-IoT.
Topology 4: UE⇄Ambient IoT device
An A-IoT device communicates bidirectionally with a UE. The communication between UE and the A-IoT device includes A-IoT data and/or signalling.

This disclosure is applicable at least to the following deployment scenarios:
Scenario 1: Device indoors, BS indoors
Scenario 2: Device indoors, BS outdoors
Scenario 3: Device indoors, UE-based reader
Scenario 4: Device outdoors, BS outdoors
Scenario 5: Device outdoors, UE-based reader

The deployment of A-IoT can be on the same sites as an existing 3GPP deployment corresponding to the BS type, e.g., macro-cell, micro-cell, pic-cell, etc. In some embodiments, it may be expected that the deployment of A-IoT can be on new sites without an expectation of an existing 3GPP deployment. The deployment can be based on licensed or unlicensed TDD or FDD spectrum, which may be in-band to an existing deployment, in guard-band of an existing deployment, or in a standalone band. Different traffic types can be supported including device-terminated (DT) and device-originated (DO), wherein DO traffic can be further divided into DO autonomous (DO-A), and DO device-terminated triggered (DO-DTT) types.

A-IoT device is one type of a UE. Embodiments in this disclosure can be generally applicable to other types of UEs, e.g., smartphones, AR/VR devices, or any other types of IoT devices.

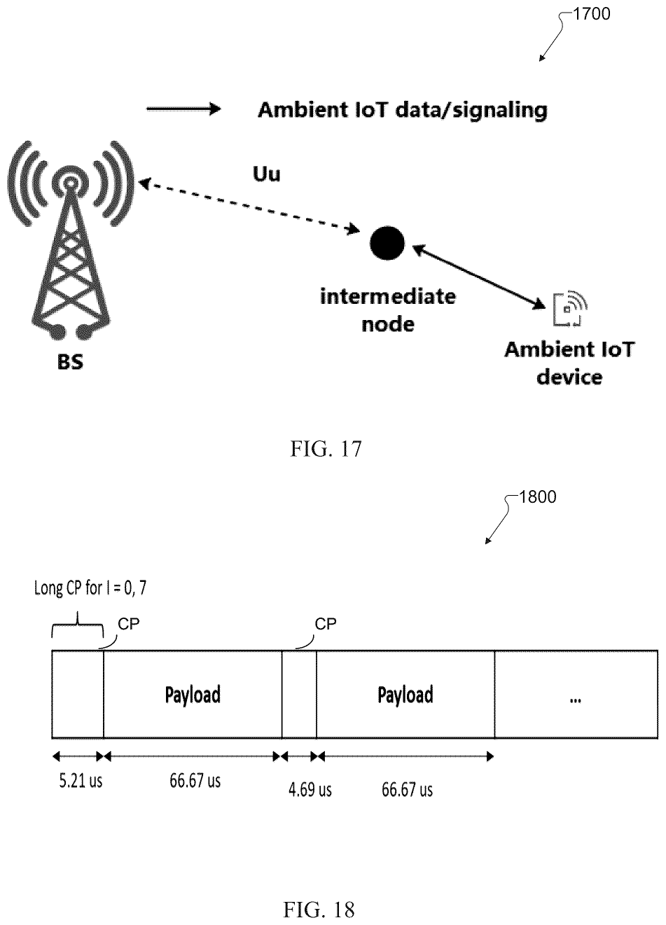

FIG. 17 illustrates an example system 1700 for D2R/R2D transmission including an intermediate UE according to embodiments of the present disclosure. For example, system 1700 can be implemented in the wireless network 100 of FIG. 1. This example is for illustration only and other embodiments can be used without departing from the scope of the present disclosure.

With reference to FIG. 17, a topology involving an intermediate node is shown, wherein the intermediate node (I-node) can be any of a UE, relay, repeater, a dedicated node, or a gNB (e.g., the BS 102). Any operations performed by a BS can be also performed by the I-node instead of the BS, and all or part of interfaces are transparent to the A-IoT devices.

An entity directly communicating with a device, or tag, is collectively termed as a reader, which can be an intermediate node as illustrated in FIG. 17, an assisting node, a UE, or a BS directly communicating with a device.

This disclosure is applicable to any of the following spectrum options, wherein a reader can be any of a BS, an intermediate node, an assisting node, or a UE in any of the topologies or scenarios disclosed herein:
CW is transmitted on DL spectrum and D2R is transmitted on the DL spectrum or shifted to UL spectrum.
CW is transmitted on UL spectrum and D2R is transmitted on the UL spectrum or shifted to DL spectrum.
R2D transmission by a reader is on DL spectrum or UL spectrum.
A node transmitting the CW can be a node inside the topology, e.g., a BS, an intermediate node, an assisting node, or a UE (e.g., the UE 116), or a node outside the topology, e.g., a dedicated CW source.
A reader receiving D2R transmission and a reader transmitting R2D may be the same or different.
As an example, CW is transmitted on DL spectrum and D2R transmission is shifted to UL spectrum, wherein the node transmitting the CW is a node inside topology or outside topology, and a reader transmitting R2D and a reader receiving D2R may be the same or different.
As another example, CW is transmitted on DL or UL spectrum and D2R transmission is on the same spectrum for which the CW is transmitted, wherein the node transmitting the CW is a node inside topology or outside topology, and a reader transmitting R2D and a reader receiving D2R may be the same or different.

A physical channel for reader to device transmission is referred to as a physical reader to device (R2D) channel (PRDCH), and a physical channel for device to reader transmission is referred to as a physical device to reader (D2R) channel (PDRCH) in this disclosure.

For PRDCH and PDRCH transmission, a timing acquisition signal, e.g., a preamble, is included at least for timing acquisition and for indicating the start of the transmission in time domain, respectively.

There may be a timing relationship between transmissions as herein:
T_{R2D_min}, T_{R2D_max}: Minimum/maximum time between a R2D transmission and the corresponding D2R transmission following it.
T_{D2R_min}, T_{D2R_max}: Minimum/maximum time between a D2R transmission and the corresponding R2D transmission following it.
T_{R2D_R2D_min}, T_{R2D_R2D_max}: Minimum/maximum time between two different consecutive R2D transmissions to the same A-IoT device.
T_{D2R_D2R_min}, T_{D2R_D2R_max}: Minimum/maximum time between two different consecutive D2R transmissions from the same A-IoT device.

Given the low complexity and the low power consumption requirements for A-IoT devices, it is apparent that the oscillators equipped with A-IoT devices will be significantly subpar to that equipped with a normal NR UE. It is therefore impractical to expected a precise timing capability for A-IoT devices as it is usually expected for normal NR UEs. Furthermore, given that A-IoT devices are powered by harvesting energy, the device maybe running out of power time to time and, thereby, loosing timing, i.e., lacking timing maintaining capability.

The A-IoT reader may reuse the existing NR hardware for generating OOK signal based on underlying CP-OFDM waveform. This may be also intended for minimizing interference impact to existing other NR UEs served using CP-OFDM waveform. Therefore, embodiments of the present disclosure recognize that there is a need to define procedures and methods for generating OOK signal based on underlying CP-OFDM waveform including aligning OOK signals into OFDM symbol boundary and attaching CP.

Given that A-IoT devices lack of precise timing maintenance capability, a receiver may not know the underlying OFDM symbol index. As the CP length can be different for symbols with different indexes, a receiver requires to know the underlying OFDM symbol index to remove the CP before reading the received OOK signal. Therefore, embodiments of the present disclosure further recognize that there is another need to define procedures and methods for aligning OOK signal transmission to OFDM half-slot boundaries or indicating underlying OFDM symbol index for the determination of CP length.

When OOK signal is mapped to one or more consecutive OFDM symbols, the last OFDM symbol duration may not be fully occupied. This unoccupied symbol duration may not be utilized for other transmissions. Also, the partially occupied symbol may induce unpredictable interference level changes during the symbol to other coexisting devices, e.g., NR UEs. Therefore, embodiments of the present disclosure further recognize that there is another need to define procedures and methods for handling the end of signal when the underlying last OFDM symbol is not fully occupied including bit or chip level padding.

In order to extend the coverage of a system, a transmission may be repeated over multiple times for improved signal reception quality. Therefore, embodiments of the present disclosure further recognize that there is another need to define procedures and methods for repetition for OOK signal based on CP-OFDM waveform including bit-level and block-level repetition and indication of repetition factors.

The disclosure relates to a communication system. The disclosure relates to defining functionalities and procedures for communication with A-IoT devices which may be lacking a precise timing capability and may operate in a passive or active transmission mode.

The disclosure relates to generating OOK signal based on CP-OFDM waveform.

The disclosure also relates to aligning OOK signal transmission to OFDM half-slot boundaries for the determination of CP length.

The disclosure also relates to indicating underlying OFDM symbol index for OOK signal reception for the determination of CP length.

The disclosure further relates to handling the end of signal when the underlying last OFDM symbol is not fully occupied including bit or chip level padding.

The disclosure also relates to defining repetition for OOK signal based on CP-OFDM waveform including bit-level and block-level repetition and indication of repetition factors.

Embodiments of the disclosure for communication with A-IoT devices, which may be lacking a precise timing capability and may operate in a passive or active UL transmission mode, are summarized in the following and are fully elaborated further herein.
Method and apparatus for generating OOK signal based on CP-OFDM waveform.
Method and apparatus for aligning OOK signal transmission to OFDM half-slot boundaries for the determination of CP length.
Method and apparatus for indicating underlying OFDM symbol index for OOK signal reception for the determination of CP length.
Method and apparatus for handling the end of signal when the underlying last OFDM symbol is not fully occupied including bit or chip level padding.
Method and apparatus for repetition for OOK signal based on CP-OFDM waveform including bit-level and block-level repetition and indication of repetition factors.

FIG. 18 illustrates example CP-OFDM symbols 1800 according to embodiments of the present disclosure. For example, CP-OFDM symbols 1800 can be received by any of the IoT devices described herein. This example is for illustration only and other embodiments can be used without departing from the scope of the present disclosure.

The general principle for OOK signal generation based on CP-OFDM waveform includes encoding OOK chips generated by encoding schemes on top of CM-OFDM waveform. Such encoding schemes include Manchester encoding, PIE (Pulse-Interval Encoding), Miller encoding, FMO encoding, any other types of line-coding schemes, or even no line-coding schemes such as based on square-wave modulation. The following OOK schemes based on CP-OFDM waveform can be evaluated.
OOK-1: Single-chip in 1 OFDM symbol. OOK=1 means N sub-carriers (SCs) are modulated. OOK=0 means SCs are zero power (from base-band point of view).
OOK-2: Parallel M-bit OOK in frequency domain. N SCs are further separated into M segments possibly with guard-bands in-between and/or around. OOK=1 means SCs in segment are modulated. OOK=0 means SCs in segment are zero power (from base-band point of view).
OOK-3: Multi-tone single-bit OOK. N SCs are separated into L segments without guard-bands in-between segment, but possibly around. OOK=1 means 1 sub-carrier (known by receiver) of each segment is modulated, rest of SC is zero power (from base-band point of view). OOK=0 means SCs in segments are zero power (from base-band point of view).
OOK-4: Transform M-bit OOK in time domain. N SCs of OOK-1 are generated by a transformation (DFT/Least square). N′ samples are generated from M-bits. Signal modification and/or truncation may or may not be used. The resulting samples, N, are mapped to N SCs.

The disclosure is applicable to any encoding schemes, any OOK modulation schemes with different M values if applicable, or any underlying waveforms such as CP-OFDM or its variants including DFT-s-OFDM, etc.

With reference to FIG. 18, an example CP-OFDM symbols in time domain (assuming 15 kHz SCS) is shown according to the disclosure. The disclosure is applicable to any different values of SCS, such as 30/60/120 kHz, or any choice of CP lengths including extended CPs. In the example of FIG. 18, it is expected that a slot includes 14 symbols and the₀th and₇th symbols from the 14 symbols have long CP (LCP) duration (5.21 us) compared to other symbols having normal CP (NCP) duration (4.69 us).

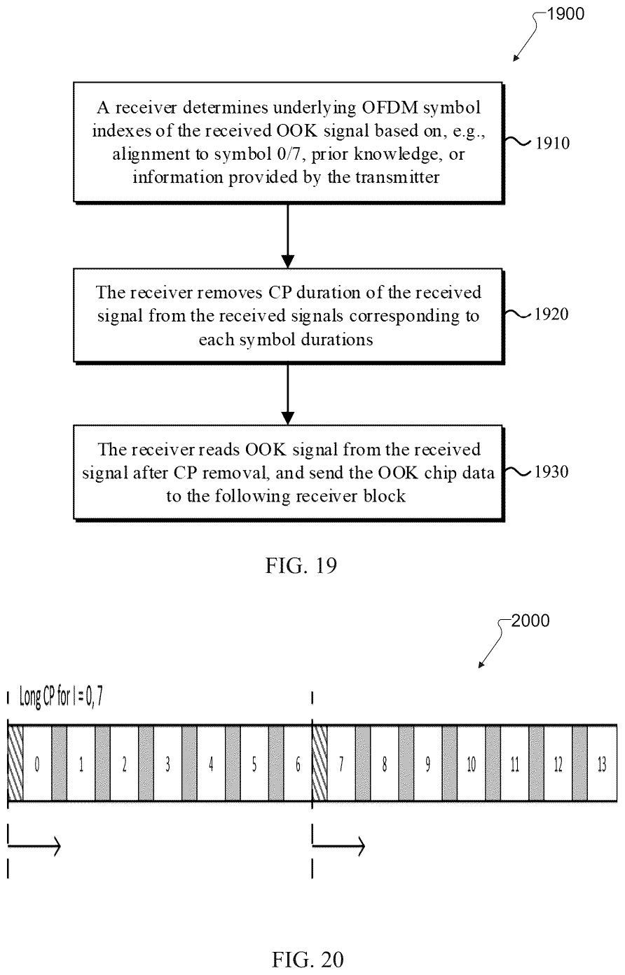

FIG. 19 illustrates a flowchart of an example procedure 1900 for sending OOK chip data according to embodiments of the present disclosure. For example, procedure 1900 can be performed by any of the IoT devices described herein. This example is for illustration only and other embodiments can be used without departing from the scope of the present disclosure.

In step 1, a receiver determines underlying OFDM symbol indexes of the received OOK signal based on, e.g., alignment to symbol 0/7, prior knowledge, or information provided by the transmitter 1910. In step 2, the receiver removes CP duration of the received signal from the received signals corresponding to each symbol durations 1920. In step 3, the receiver reads OOK signal from the received signal after CP removal, and send the OOK chip data to the following receiver block 1930.

The OOK signal based on CP-OFDM waveform may be generated and transmitted by a reader and it is received by a device, or vice versa. For some examples, it is described that a reader takes the role of a transmitter and a device takes the role of a receiver, wherein the opposite is also feasible.

In one example for Manchester encoding, bit 0 is mapped to chips {10}and bit 1 is mapped to chips {01}. The opposite is also feasible. For PIE encoding, bit 0 is mapped to chips {10}and bit 1 is mapped to chips {110}, {1110}, {100}, or {1000}, expecting fixed chip duration. If variable chip duration is evaluated, for PIE encoding both bit 0 and bit 1 are mapped to chips {10}(or {01}) but with different lengths of chip 1, or different lengths of chip 0, to distinguish bit 0 and bit 1. The representation of chip 1 or 0 is from a base-band point of view and they may correspond to high-voltage or low-voltage states from an actual transmission point of view.

For OOK-1 as an example, one chip, either 0 or 1, is encoded over one payload duration, denoted by Lₚₗ, and then the symbol is extended by prepending CP, by copying the last L_{CP} duration of the signal from the payload.

The length of a chip is equal to Lₚₗ/M, for OOK-4. In one embodiment, the supported M values are upper bounded by Mₘₐₓ, such that L_{CP} is no longer than one chip duration, Lₚₗ/M. For NCP, Mₘₐₓ=14. For LCP, Mₘₐₓ=12. Thus, the supported M value may be limited to 12 in the specifications of system operation.

With reference to FIG. 19, an example flowchart of a receiver to receive OOK signal based on CP-OFDM is shown according to the disclosure.

FIG. 20 illustrates example CP-OFDM symbols 2000 according to embodiments of the present disclosure. For example, CP-OFDM symbols 2000 can be received by any of the IoT devices described herein. This example is for illustration only and other embodiments can be used without departing from the scope of the present disclosure.

With reference to FIG. 20, an example of a slot including 14 CP-OFDM symbols (assuming 15 kHz SCS) is shown according to the disclosure. The disclosure is applicable to any different values of SCS.

In one embodiment, a start of OOK transmission is aligned with NR symbol l=0, 7, i.e., slot or half-slot boundary. Therefore, a receiver can determine that the first received symbol corresponds to LCP and the following 6 symbols correspond to LCP and repeats. Based on this determination, a device removes LCP duration and NCP duration of signals from the received signal when decoding each symbols from the received signal.

In another embodiment, a device has a prior knowledge on the presence of CPs in the received OOK signal. In one example, it may depend on a deployment scenario such as standalone or non-standalone (e.g., in-band or guard-band) deployment with no adjacent NR UEs. For certain deployment scenarios as exemplified, a receiver is preconfigured on whether CP-OFDM is used or not as an underlying waveform, i.e., necessity to handle CP at the receiver side. In another example, it may depend on a used coding scheme. For instance, when PIE encoding scheme is used, the receiver may expect that CP-OFDM is not used, i.e., CP does not present.

In another example, a broadcast information, e.g., R2D broadcast information provided in a PRDCH or in a separate dedicated physical channel, provides the symbol index of the start of a current transmission providing the broadcast information or a following transmission. Similarly, in one embodiment, any PRDCH transmission may include symbol index of the start of the current transmission, in L1, L2, or any higher layer control information. By utilizing this timing reference, a receiver can determine a symbol index of a later received signals, and remove CPs accordingly.

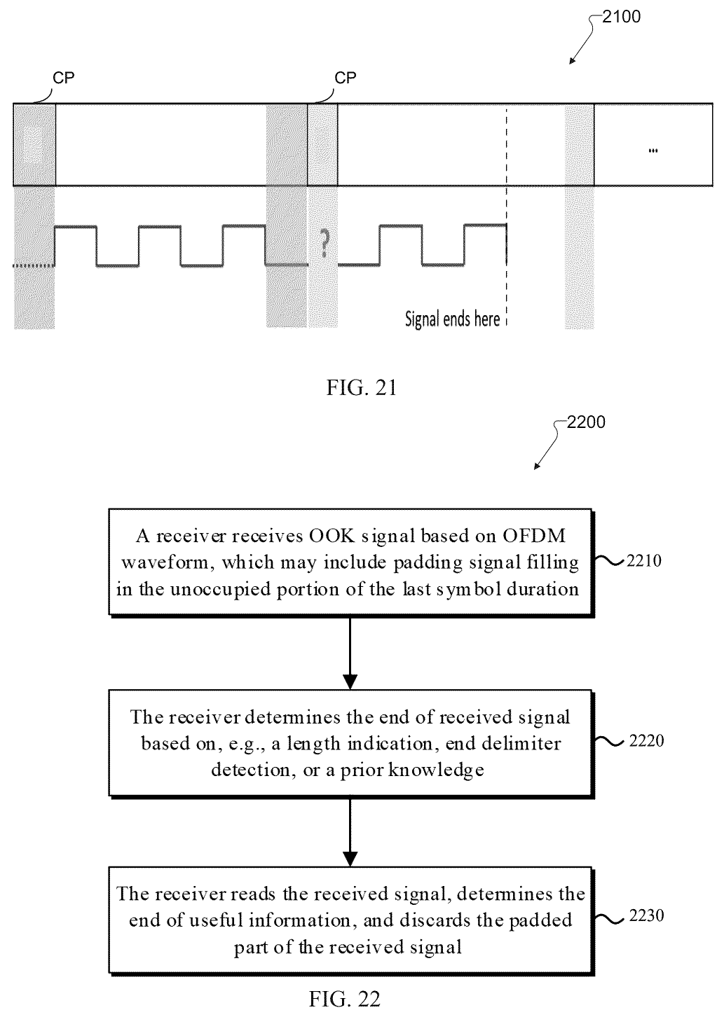

With reference to FIG. 21, an issue is shown for handling partially occupied OFDM symbol with OOK chips according to the disclosure.

FIG. 21 illustrates an example transmission 2100 according to embodiments of the present disclosure. For example, transmission 2100 can be received by any of the IoT devices described herein. This example is for illustration only and other embodiments can be used without departing from the scope of the present disclosure.

A transmission comprising of a sequence of OOK chips occupies one or more consecutive OFDM symbol durations and the last symbol may not be fully occupied with OOK chips as illustrated in FIG. 21. In one embodiment, the last symbol, which is not fully occupied with OOK chips, is left unoccupied, i.e., no transmission. It can be zero power on the subcarriers at least from base band perspective, which can be different and has certain power level in the RF domain. In this case, from a transmitter point of view, the unoccupied remaining symbol duration is regarded as a part of signal and the CP is copied from the unoccupied symbol duration. Therefore, the CP duration may be seen unoccupied in this case. This is applicable for both cases with CRC attachment or without CRC attachment.

The unoccupied remaining symbol duration may be left unutilized. For instance, a following PRDCH transmission may start from the next symbol boundary. In yet another example, a subsequent PDRCH transmission may be scheduled to start from the next symbol boundary.

FIG. 22 illustrates a flowchart of an example procedure 2200 for determining the end of useful information of a received signal. For example, procedure 2200 can be performed by any of the IoT devices described herein. This example is for illustration only and other embodiments can be used without departing from the scope of the present disclosure.

In step 1, a receiver receives OOK signal based on OFDM waveform, which may include padding signal filling in the unoccupied portion of the last symbol duration 2210. In step 2, the receiver determines the end of received signal based on, e.g., a length indication, end delimiter detection, or a prior knowledge 2220. In step 3, the receiver reads the received signal, determines the end of useful information, and discards the padded part of the received signal 2230.

With reference to FIG. 22, an example flowchart of a receiver to receive OOK signal based on OFDM including padding signal is shown according to the disclosure.

In one embodiment, the unoccupied remaining symbol duration may be padded with
A number of consecutive OOK chips of {1}.
A number of consecutive OOK chips of {0}.
A number of consecutive OOK chips of {01}.
A number of consecutive OOK chips of {10}.
A number of consecutive data bits of {0}, which is mapped to OOK chips, e.g., bit 0 →chips {10}.
A number of consecutive data bits of {1}, which is mapped to OOK chips, e.g., bit 1 →chips {01}.
A number of consecutive data bits of {01}.
A number of consecutive data bits of {10}.

In one example, for the cases of data bit padding, e.g., a number of consecutive data bits of {0}, the padding may be performed before CRC attachment. Thus, a receiver reads CRC bits from the end of the received signal. The CRC check is performed for the entire received data bits including padded bits. The receiver obtains information related to payload size, e.g., number of padded bits, or the meaningful payload size excluding the padded bits.

In another example, for the cases of OOK chip or data bit padding, the padding may be performed after CRC attachment. In one example, the receiver has knowledge on the signal transmission duration, e.g., for a signal type with known transmission duration or via indication in the received signal using L1, L2, or any higher layer control information, e.g., in a header field. In this case, the receiver stops reading the received signal from the padded part and ignores the rest of signal. In yet another example, the receiver detects the end of signal using postamble, also known as end delimiter. In one case, the end delimiter, i.e., postamble, is attached right after the end of chips carrying useful information including CRC, and the remaining unoccupied time duration until the next OFDM symbol boundary is filled in with padding signal. In this case, once the receiver detects the end delimiter, the receiver stops reading the rest of the received signal and, thus, the padded part is ignored. In another case, the end delimiter is attached such that it occupies the end of symbol until the start of the next symbol boundary, and the padding signal is added such that the resulting padding chips fill in the unoccupied time duration until the start of the end delimiter. In this case, the receiver obtains information regarding the signal transmission duration, e.g., for a signal type with known transmission duration or via indication in the received signal using L1, L2, or any higher layer control information, e.g., in a header field, obtains CRC bits for CRC check. Therefore, the padded part are ignored for CRC check.

In yet another example, the transmitter may not attach CRC bits while the transmitter adds padding signal to fill in the unoccupied symbol duration. In one example, the receiver has knowledge on the signal transmission duration, e.g., for a signal type with known transmission duration or via indication in the received signal using L1, L2, or any higher layer control information, e.g., in a header field. In this case, the receiver stops reading the received signal from the padded part and ignores the rest of signal. In yet another example, the receiver detects the end of signal using end delimiter. In one case, the end delimiter is attached right after the end of chips carrying useful information, and the remaining unoccupied time duration is filled in with padding signal. In this case, once the receiver detects the end delimiter, the receiver stops reading the rest of the received signal and, thus, the padded part is ignored. In another case, the end delimiter is attached such that it occupies the end of symbol until the start of the next symbol boundary, and the padding signal is added such that the resulting chips fill in the unoccupied time duration until the start of the end delimiter. In this case, the receiver obtains information regarding the signal transmission duration, e.g., for a signal type with known transmission duration or via indication in the received signal using L1, L2, or any higher layer control information.

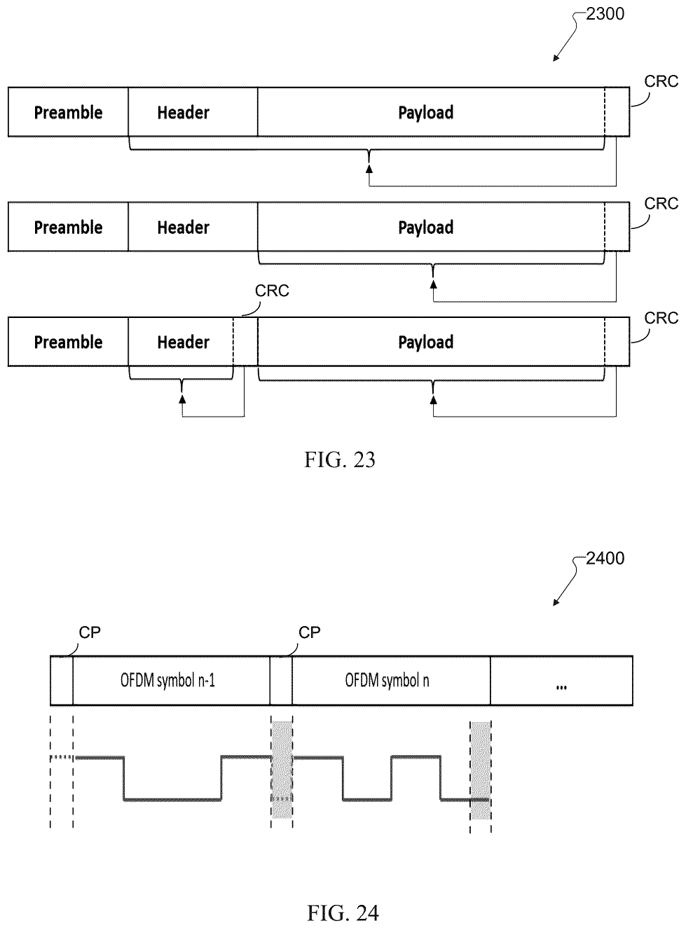

FIG. 23 illustrates an example signal structure 2300 according to embodiments of the present disclosure. For example, signal structure 2300 can be received by any of the IoT devices described herein. This example is for illustration only and other embodiments can be used without departing from the scope of the present disclosure.

In the first figure, a single CRC is attached for the entire header and payload blocks. In the second figure, the header is not a part of CRC and a single CRC is attached for payload block. In the third figure, separate CRCs are attached for the header block and the payload block, respectively.

In one embodiment, the bits received from higher layers and/or physical layer after CRC attachment are block-wise repeated.

When a single CRC is attached for the entire header and payload blocks, the entire {Header, Payload, CRC}block is repeated N times. N is a positive integer, i.e., 1, 2, . . . . In one example, N can take values from 1, 2. In this case, 1 bit is used to indicate the repetition factor from 1, 2. In another example, N can take values from 1, 2, 4, 8. In this case, two bits are used to indicate the repetition factor from 1, 2, 4, 8.

When separate CRCs are attached for header and payload, respectively, or a single CRC is for payload only and header is not part of CRC check, in one example, {Header, [CRC]}block is repeated N₁ times, followed by {Payload, CRC}block, repeated N₂ times. The square bracket, [CRC], implies that the CRC may or may not exist depending on a case, and N₁ and N₂ are positive integers, i.e., 1, 2, . . . N₁ and N₂ can be the same or different. In one example, N₁ and N₂ can take values from 1,2 or 1, 2, 4, 8. When N₁ and N₂ are separately indicated, each indication uses two bits to indicate the repetition factor from 1,2 or 1, 2, 4, 8. In one example, any of N, N₁ and N₂ may be fixed and the value is defined in a specification of system operations and not separately indicated. As an example, Nᵢ is 1 and it is expected by a receiver without separate indication.

The repetition factor may be provided in the header field of signal structure in FIG. 23. In another example, there is a field, which may be separate from or a part of the header field, having a fixed number of bits indicating the repetition factor. For PDRCH, the repetition factor is indicated in the preceding PRDCH.

When the last OFDM symbol is not fully occupied after repetition, method disclosed herein, i.e., left unoccupied or filling in with padding signal, can be applied. Alternatively, a block is partially repeated to fill in the last symbol. In this case, the initial part of the block is repeated until the last OFDM symbol is fully occupied. This partial repetition may or may not be counted as a repetition factor when it is indicated or expected by a receiver. Alternatively, the last partially unoccupied symbol is not transmitted, i.e., truncated. In one example, this truncation is separately indicated to the receiver. In one example, such truncation indication is provided using 1 bit indication. In another example, such truncation indication is not provided.

In another embodiment, each bit after CRC attachment or after CRC attachment and forward error correction (FEC), if used, is repeated bit-wise.

In one example, the bits in {Header, [CRC], Payload, CRC}block, before or after FEC, is repeated N times bit-wise. In another example, the bits in {Header, [CRC]}is repeated N₁ times bit-wise, and then bits in {Payload, CRC}is repeated N₂ times bit-wise, either before or after FEC.

For the indication of N, N1, and N₂, the methods disclosed for block-wise repetition can be applied similarly.

In one embodiment, after repetition, bit-interleaving is performed. After interleaving, a number of consecutive repeated bits are shuffled with other bits in the block. When the bits in {Header, [CRC], Payload, CRC}block, before or after FEC, is repeated N times bit-wise, a single interleaving is performed for the entire bits. When the bits in {Header, [CRC]}is repeated N₁ times bit-wise, and then bits in {Payload, CRC}is repeated N₂ times bit-wise, either before or after FEC, single interleaving is performed for the entire bits or separate interleaving is performed for {Header, [CRC]}block and {Payload, CRC}block, respectively, after repetition. When N, N₁, or N₂ is 1, i.e., no repetition, interleaving is not performed for the entire or the corresponding block.

When the last OFDM symbol is not fully occupied after repetition, method disclosed herein, i.e., left unoccupied or filling in with padding signal, can be applied. Alternatively, the last partially unoccupied symbol is not transmitted, i.e., truncated. In one example, this truncation is separately indicated to the receiver. In one example, such truncation indication is provided using 1 bit indication. In another example, such truncation indication is not provided.

For OOK signal generation based on CP-OFDM waveform, the CP insertion can be still beneficial in terms of reusing the existing OFDM hardware for OOK signal generation and also for other UEs served using OFDM waveform by maintaining the sub-carrier orthogonality. However, the attachment of CP can introduce false falling and rising edges, which can be interpreted as an additional chip other than the intended signaling, or increase the length of the first chip in the OFDM symbol. Therefore, embodiments of the present disclosure further recognize that there is a need to define procedures and methods for a receiver to correctly detect OOK chips with an attachment of CP.

With the same motivation, there is another need to define procedures and methods for a transmitter to attach CP to OOK signal without incurring a false rising/falling edges while evaluating the values of the first and the last chips of the current and the previous OFDM symbols and minimizing the cases where sub-carrier orthogonality is not maintained.

With the same motivation, there is yet another need to define procedures and methods for a transmitter to generate preamble signal, including start-indicator and clock acquisition parts, using OOK based on CP-OFDM waveform without incurring a false rising/falling edges and maintaining sub-carrier orthogonality.

Alignments of the length of a signal to an OFDM symbol boundary has advantages in terms of CP generation and the signal length indication. Therefore, there is yet another need for a transmitter to align the end of a signal, or the end of one or multiple segments of a signal divided by midambles, and to indicate the length of a signal in a unit of OFDM symbol durations.

The disclosure relates to a communication system. The disclosure relates to defining functionalities and procedures for communication with A-IoT devices which may be lacking a precise timing capability and may operate in a passive or active transmission mode.

The disclosure relates to defining functionalities and procedures for a transmitter to generate OOK signal based on CP-OFDM waveform.

The disclosure also relates to defining functionalities and procedures for a receiver to detect OOK chips with a presence of CP without transmitter side modification.

The disclosure further relates to defining functionalities and procedures for a transmitter to attach CP to OOK signal without incurring a false rising/falling edges while partially preserving the orthogonality.

The disclosure also further relates to defining functionalities and procedures for a transmitter to generate preamble signal, including start-indicator and clock acquisition parts, using OOK based on CP-OFDM waveform.

The disclosure further relates to defining functionalities and procedures for a transmitter to align the end of a signal, or the end of one or multiple segments of a signal divided by midambles, and to indicate the length of a signal in a unit of OFDM symbol durations.

Embodiments of the disclosure for communication with A-IoT devices, which may be lacking a precise timing capability and may operate in a passive or active UL transmission mode, are summarized in the following and are fully elaborated further herein.
Method and apparatus for a transmitter to generate OOK signal based on CP-OFDM waveform.
Method and apparatus for a receiver to detect OOK chips with a presence of CP without transmitter side modification.
Method and apparatus for a transmitter to attach CP to OOK signal without incurring a false rising/falling edges while partially preserving the orthogonality.
Method and apparatus for a transmitter to generate preamble signal, including start-indicator and clock acquisition parts, using OOK based on CP-OFDM waveform.
Method and apparatus for a transmitter to align the end of a signal, or the end of one or multiple segments of a signal divided by midambles, and to indicate the length of a signal in a unit of OFDM symbol durations.

In one example for Manchester encoding, bit 0 is mapped to chips {10}and bit 1 is mapped to chips {O1}. The opposite is also feasible. For PIE encoding, bit 0 is mapped to chips {10}and bit 1 is mapped to chips {110}, {1110}, {100}, or {1000}, assuming fixed chip duration. If variable chip duration is taken into account, for PIE encoding both bit 0 and bit 1 are mapped to chips {10}(or {O1}) but with different lengths of chip 1, or different lengths of chip 0, to distinguish bit 0 and bit 1. The representation of chip 1 or 0 is from a base-band point of view and they may correspond to high-voltage or low-voltage states from an actual transmission point of view.

For OOK-1 as an example, one chip, either 0 or 1, is encoded over one payload duration, denoted by Lₚₗ, and then the symbol is extended by prepending CP, by copying the last L_{CP} duration of the signal from the payload.

The length of a chip is equal to Lₚₗ/M, for OOK-4. In one embodiment, the supported M values are upper bounded by Mₘₐₓ, such that L_{CP} is no longer than one chip duration, Lₚₗ/M. For NCP, Mₘₐₓ=14. For LCP, Mₘₐₓ=12. Thus, the supported M value may be limited to 12 in the specifications of system operation.

FIG. 24 illustrates example CP-OFDM symbols 2400 according to embodiments of the present disclosure. For example, CP-OFDM symbols 2400 can be received by any of the receiver devices described herein, such as the IoT devices described herein. This example is for illustration only and other embodiments can be used without departing from the scope of the present disclosure.

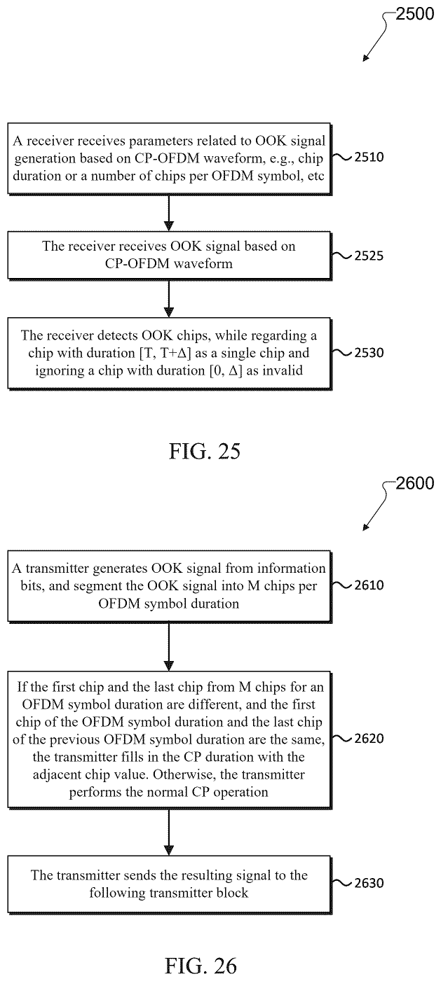

FIG. 25 illustrates a flowchart of an example procedure 2500 for detecting OOK chips according to embodiments of the present disclosure. For example, procedure 2500 can be performed by any of the IoT devices described herein. This example is for illustration only and other embodiments can be used without departing from the scope of the present disclosure.

A receiver receives parameters related to OOK signal generation based on CP-OFDM waveform, e.g., chip duration or a number of chips per OFDM symbol, etc. 2510. The receiver receives OOK signal based on CP-OFDM waveform 2525. The receiver detects OOK chips, while regarding a chip with duration [T, T+A]as a single chip and ignoring a chip with duration [0, A]as invalid 2530. T is a used chip duration and A is a margin for a chip duration in detecting a chip.

In CP-OFDM waveform, the CP is copied from the end of the symbol and then prepended at the start of the corresponding symbol. The CP is removed at the receiver when capturing the samples for the FFT window and, therefore, it serves as a guard time to mitigate the inter-symbol interference. By prepending the CP in a circular manner, it also allows to maintain sub-carrier orthogonality and, thereby, preventing inter-carrier interference.

For OOK signal generation based on CP-OFDM waveform, the CP insertion can be still beneficial in terms of reusing the existing OFDM hardware for OOK signal generation and also for other UEs served using OFDM waveform by maintaining the sub-carrier orthogonality.

With reference to FIG. 24, an example is shown of CP attachment for OOK signal based on CP-OFDM according to the disclosure.

In OFDM symbol n-1, the first OOK chip and the last OOK chip has the same state. Therefore, prepending the CP by copying the last chip has an effect of extending the first OOK chip duration. If the CP length is comparable to a chip duration, the copied CP portion of a signal can be interpreted as another chip of a same state. In OFDM symbol n, the first OOK chip and the last OOK chip has different states. Therefore, prepending the CP by copying the last chip can introduce false falling and rising edges, which can be interpreted as another chip having different state. This can be regarded as an invalid chip. If the CP duration is identified and removed at the receiver, these issues are negligible. CP duration identification and removal can be challenging for devices lacking precise timing maintenance capability, such as A-IoT devices.

With reference to FIG. 25, an example flowchart of a receiver to detect OOK chips for OOK signal based on CP-OFDM is shown according to the disclosure.

In one embodiment, when a receiver detects that a chip of a certain state has duration of [T, T+Δ], where T is the nominal chip duration, the receiver interprets it as a single chip. Similarly, in another embodiment, when a receiver detects that a chip of a certain state has duration of [0, Δ], the receiver ignores it and does not interpret it as a valid chip, i.e., discarded. The margin A can be defined in an absolute amount of time, e.g., in units of us, or in a relative amount of time, e.g., a percentage of the used chip duration. In one example, A can be 10%, 20%, 30%, 40%, or 50% of the used chip duration, T. The margin Δ can be predefined in a specification of system operations or indicated to the receiver, e.g., via L1, L2, or any higher control information.

In another embodiment, there is a restriction on the supported OOK M values such that the CP duration remains relatively smaller than a used chip duration. As an example, for A=0.5T, in order for a CP duration to remain smaller than Δ, the maximum supported M value, Mₘₐₓ is 7 when taking into account normal CP length of 4.69 us and 6 when taking into account long CP length of 5.21 us. For instance, Mₘₐₓ=6 and the value is predefined in a specification of system operations. If M={1, 2, 4, 6}are supported, a receiver is indicated the OOK M value using two-bit indication.

In one embodiment, a transmitter ensures that the first OOK chip and the last OOK chip in an OFDM symbol are the same. For OOK-4 with M value, as an example, the transmitter maps M-1 chips to a symbol duration and either copy the first chip and append it at the end or copy the last chip and prepend it at the beginning to make total M chips. In this case, the first and the last OOK chip are the same and, therefore, the CP attachment operation does not create any false rising/falling edges. The receiver then discards the copied last or first OOK chip, depending on the appending or prepending operation, from chips mapped to each OFDM symbol duration.

FIG. 26 illustrates a flowchart of an example procedure 2600 for CP attachment according to embodiments of the present disclosure. For example, procedure 2600 can be performed by any of the transmitter devices described herein. This example is for illustration only and other embodiments can be used without departing from the scope of the present disclosure.

A transmitter generates OOK signal from information bits, and segment the OOK signal into M chips per OFDM symbol duration 2610. If the first chip and the last chip from M chips for an OFDM symbol duration are different, and the first chip of the OFDM symbol duration and the last chip of the previous OFDM symbol duration are the same, the transmitter fills in the CP duration with the adjacent chip value. Otherwise, the transmitter performs the normal CP operation 2620. The normal CP operation refers to the operation of copying a CP duration of the signal from the end of the symbol and then prepending it at the start of the corresponding symbol. The transmitter sends the resulting signal to the following transmitter block 2630.

With reference to FIG. 26, an example flowchart of a transmitter for CP attachment for OOK signal based on CP-OFDM with partial orthogonality is shown according to the disclosure.

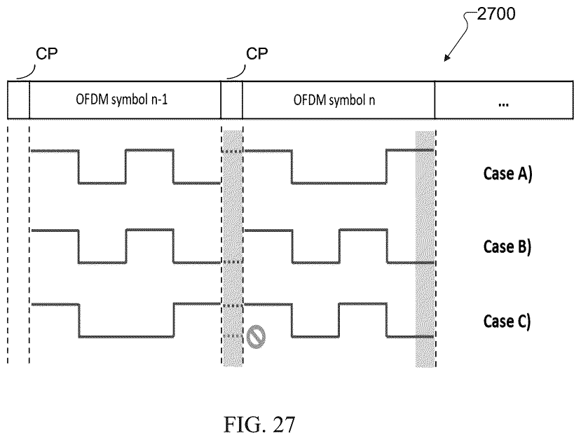

FIG. 27 illustrates examples of CP-OFDM symbols 2700 according to embodiments of the present disclosure. For example, CP-OFDM symbols 2700 can be received by any of the receiver devices described herein, such as the IoT devices described herein. This example is for illustration only and other embodiments can be used without departing from the scope of the present disclosure.

With reference to FIG. 27, an example of different cases for CP attachment for OOK signal based on CP-OFDM with partial orthogonality is shown according to the disclosure.

In Case A), the first chip and the last chip of current OFDM symbol n are the same. In this case, the transmitter performs the normal CP operation and, as a result, the first chip is extended by the CP duration of the same chip value. The Case A) accounts for 50% of the cases and the sub-carrier orthogonality is maintained.

In Case B), the first chip and the last chip of current OFDM symbol n are different, and the last chip of OFDM symbol n and the last chip of the previous OFDM symbol n-1 are the same. In this case, the transmitter performs the normal CP operation and, as a result, the last chip of the previous OFDM symbol n-1 is extended by the CP duration of the same chip value. The Case B) accounts for 25% of the cases and the sub-carrier orthogonality is maintained.

In Case C), the first chip and the last chip of current OFDM symbol n are different, and the last chip of OFDM symbol n and the last chip of the previous OFDM symbol n-1 are different. Equivalently, the first chip of the OFDM symbol n and the last chip of the previous OFDM symbol n-1 are the same. In this case, if the transmitter performs the normal CP operation, it will create a false rising/falling edges as illustrated in the figure. Therefore, in one embodiment, the transmitter fills in the CP duration with the adjacent chip value and, as a result, the last chip of the previous OFDM symbol n-1 or, equivalently, the first chip of the current OFDM symbol n is extended by the CP duration of the same chip value. The Case C) accounts for 25% of the cases and the sub-carrier orthogonality is not maintained. In another embodiment, the transmitter performs the normal CP operation and the false rising/falling edges are handled at the receiver as disclosed herein, i.e., ignoring a chip with duration [0, Δ]as invalid, where A is set to the CP duration with some ±6 margin, e.g., 6 as a percentage of the target duration, i.e., CP duration in this case. In this case, the sub-carrier orthogonality is maintained.

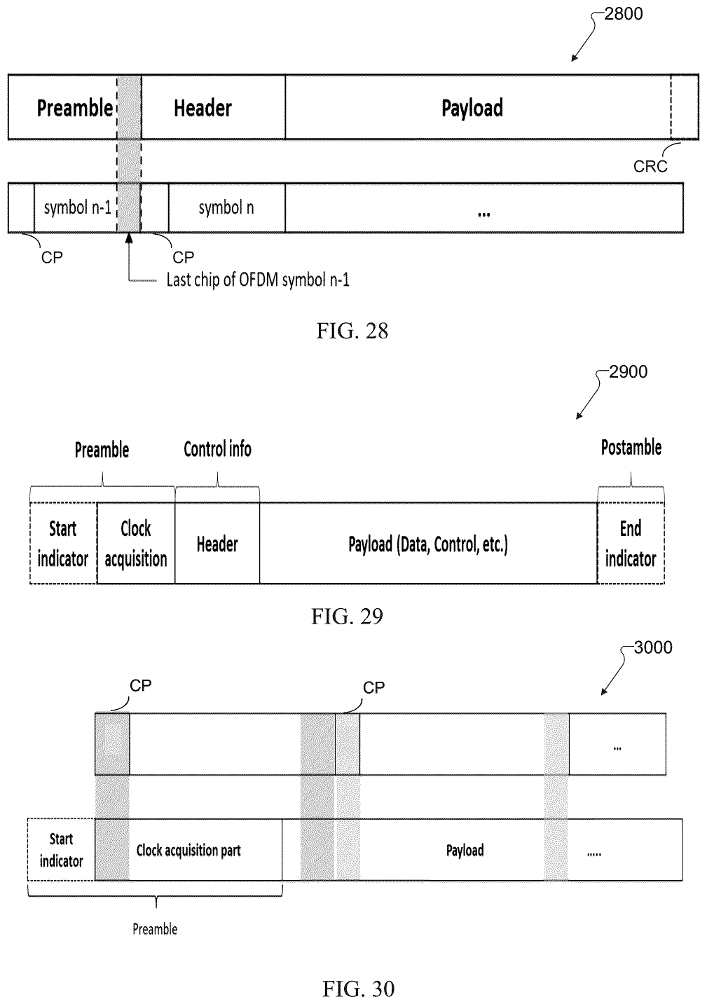

FIG. 28 illustrates an example mapping 2800 for frame structure-OFDM symbols according to embodiments of the present disclosure. For example, mapping 2800 may be utilized by any of the reader devices described herein. This example is for illustration only and other embodiments can be used without departing from the scope of the present disclosure.

If the current OFDM symbol n is the first symbol of a transmission, the transmitter may provide that the previous OFDM symbol n-1 has a last chip with value {0}. If there is a preceding signal, such as the preamble, it can be regarded as the previous OFDM symbol n-1, as illustrated in the figure herein. For an expected last chip value of the previous OFDM symbol, the CP attachment at the transmitter can be performed as disclosed herein.

With reference to FIG. 28, an example is shown of a mapping frame structure into OFDM symbol boundaries according to the disclosure.

FIG. 29 illustrates an example signal architecture 2900 according to embodiments of the present disclosure. For example, signal architecture 2900 can be designed by any of the transmitter devices described herein. This example is for illustration only and other embodiments can be used without departing from the scope of the present disclosure.

With reference to FIG. 29, an example signal structure is shown according to the disclosure.

The preamble includes a start-indicator part and a clock-acquisition part, as illustrated in the figure. In one example, the start-indicator, i.e., delimiter, can be a fixed length low voltage signal. The start-indicator field may be also utilized for the purpose of wake-up signal (WUS) for devices to stay in a sleep mode until the start-indicator field is detected. Therefore, in another example, the start-indicator field may not be a simple fixed length low voltage signal, but it can be a short sequence that can facilitate the detection of the signal for the purpose of WUS. As an example, it can be a certain high/low-voltage pattern of a signal for a certain duration. In another example, it is encoded with a number of bits, e.g., 00, 01, 10, or 11. In another example, the start-indicator part is an encoded signal of 10101011.

The clock acquisition part can be a sequence transmitted in time domain providing timing synchronization for the demodulation of the following fields, such as header and payload. It may be also used for channel estimation and setting up the automatic gain control (AGC), etc. The design of clock acquisition part will be dependent on the used encoding schemes. For instance, in the case of PIE encoding, the clock acquisition part needs to provide a calibration for signal pulse durations for bit 0 and 1, as bit 1 has different pulse duration than bit 0. In the case of Manchester encoding, the clock acquisition part can be comprised of a sufficient number of alternations between 0 and 1 chips for providing a synchronization, while the signal for bit 0 and 1 has a fixed length. In one example, the clock-acquisition part is 1010, 10101010, or 101010101010 . . . .

FIG. 30 illustrates an example mapping 3000 for preamble-OFDM symbols according to embodiments of the present disclosure. For example, mapping 3000 may be utilized by any of the reader devices described herein. This example is for illustration only and other embodiments can be used without departing from the scope of the present disclosure.

With reference to FIG. 30, an example of a mapping preamble of a signal into OFDM symbol boundaries is shown according to the disclosure.

The start-indicator, i.e., delimiter, can be a fixed length low voltage signal. In one embodiment, the end of start-indicator signal is aligned with a start of an OFDM symbol boundary and, thus, the start of clock acquisition part is aligned with the start of the OFDM symbol boundary.

In one embodiment, the clock acquisition part is one symbol long, i.e., the number of chips in the clock part is M for a chosen M value. The resulting M chips from a chosen clock acquisition sequence has a property such that the 1^{st} chip and the Mth chip has the same value and, therefore, the added CP does not incur any false edges. In another embodiment, the clock acquisition sequence is designed such that the last chip, i.e., M^{th} chip, has a value {0}such that the CP attachment only extends the length of the low voltage start indicator part and does not incur any false edges creating an invalid chip.

In another embodiment, the number of chips in the clock acquisition part, L, is an integer multiple of a set of M values supported in the system. As an example, if M={2, 4, 8}is supported, L can be 8, 16, . . . , etc. The resulting L chips from a chosen clock acquisition sequence has a property such that, when L chips are segmented into one or more groups of M chips for a value of M supported in the system, the 1^{st} chip and the Mt^{h} chip in each group has the same value and, therefore, the added CP does not incur any false edges.

The start-indicator can be a fixed length low voltage signal, and the start of the start-indicator part is aligned with a start of an OFDM symbol boundary. In one embodiment, the following clock acquisition part is designed such that it occupies one or more OFDM symbol durations and the last chip of the first OFDM symbol duration has a value {0}such that the attached CP also has a value {0}, which serves as a start indicator with a low voltage state. In another embodiment, regardless of the clock acquisition part design and the value of the last chip in the first OFDM symbol, the CP of the first OFDM symbol is enforced to have a value {0}such that the CP duration can serve as a start indicator. In this case, the orthogonality of the first OFDM symbol may or may not be maintained depending on the clock acquisition part design.

The start-indicator can be a short sequence of an on/off pattern comprised of a number of chips. In one example, the chip rate, or equivalently chip length, for the start-indicator part and that for clock acquisition part are the same. Thus, the start-indicator and the clock acquisition part may be indistinguishable at least from a chip rate point of view. In another example, the chip rate, or equivalently chip length, for the start-indicator part and that for clock acquisition part are different and one is distinguished from the other at least from a chip rate point of view.

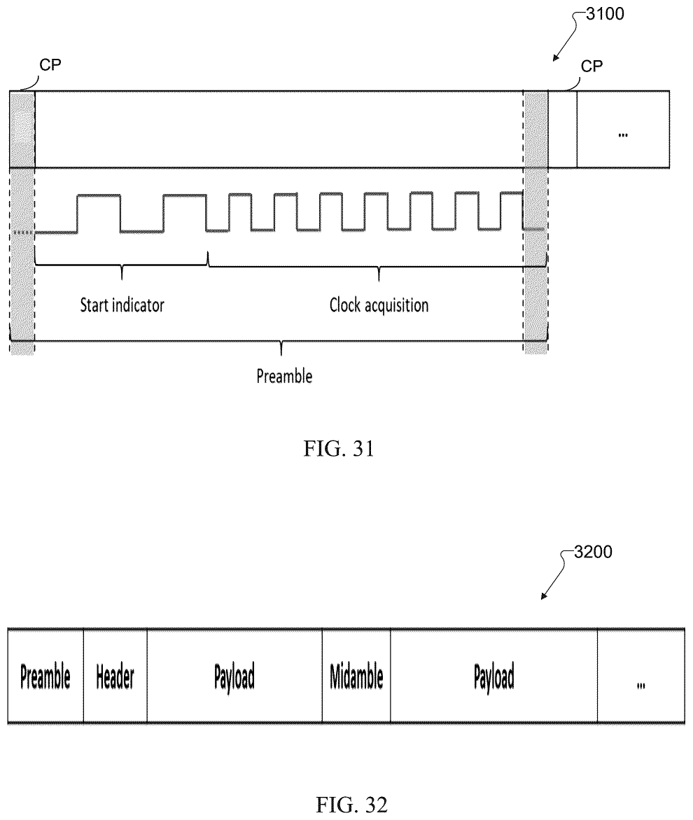

FIG. 31 illustrates an example of CP-OFDM symbols 3100 according to embodiments of the present disclosure. For example, CP-OFDM symbols 3100 can be received by any of the receiver devices described herein, such as the IoT devices described herein. This example is for illustration only and other embodiments can be used without departing from the scope of the present disclosure.

With reference to FIG. 31, an example preamble design occupying one or more symbol durations is shown according to the disclosure.

In the figure, it is exemplified that the entirety of the preamble signal occupies one OFDM symbol duration. In another example, the preamble signal is designed such that it occupies an integer number of OFDM symbol durations. In yet another example, each of the start-indicator and the clock acquisition parts occupy one or more OFDM symbol durations.

In one embodiment, the start-indicator part has a fixed chip rate. In one example, the lowest chip rate among the set of supported M values is used for the start-indicator. In one example, the start-indicator has one or more repetitions of chips {01}or {10}. The number of repetitions, or the signal itself, can be fixed and predefined in a specification of system operations or the number of repetitions, or the length of the signal itself, can be variable and used to indicate certain information. In one example, the number of repetitions indicates the chip rate of the following clock acquisition part. For instance, if M={2, 4, 8}is supported, the start indicator {01}, {0101}, and {010101}indicates M=2, 4, 8, respectively for the following clock acquisition part. The rest of the signal uses the same chip rate.

FIG. 32 illustrates an example signal architecture 3200 according to embodiments of the present disclosure. For example, signal architecture 3200 can be designed by any of the transmitter devices described herein, such as the BS 102. This example is for illustration only and other embodiments can be used without departing from the scope of the present disclosure.

With reference to FIG. 32, an example signal structure with midamble is shown according to the disclosure.

In one embodiment, the payload part of the signal is divided into one or more segments separated by midambles such that the start of each midamble is aligned with an OFDM symbol boundary.

In another embodiment, the end of the signal, either segmented with midambles or as a single segment, is aligned with an OFDM symbol boundary. The indication of the length of the signal is provided to the receiver in a unit of OFDM symbol durations. When the signal is segmented with midambles, the length of each segment is indicated in a unit of OFDM symbol durations.

The general principles disclosed for the preamble signal design can be applied for midamble signal design.

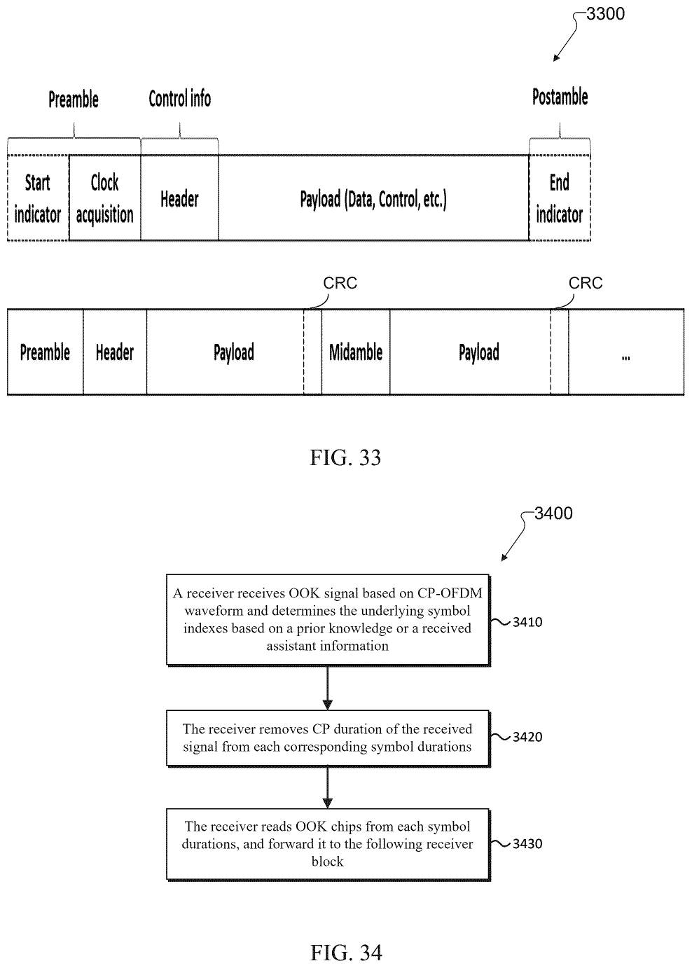

FIG. 33 illustrates an example signal architecture 3300 for A-IoT system(s) according to embodiments of the present disclosure. For example, signal architecture 3300 can be received by any of the A-IoT devices described herein. This example is for illustration only and other embodiments can be used without departing from the scope of the present disclosure.

With reference to FIG. 33, an example signal structure used for A-IoT system for R2D or D2R transmission is shown according to the disclosure. The dotted block indicates that it may or may not exist.

The first figure in FIG. 33 illustrates a general signal structure comprised of one or more of the following elements:
Start/End-indicator, i.e., delimiter: Start-of-signal and end-of-signal indication. It may be a short duration of low voltage signal or a sequence with low detection complexity prior to detecting preamble. The start-indicator is a part of the preamble. The end-indicator may be also termed as postamble. The delimiters may or may not be exist.
Clock acquisition: A sequence that provides OOK chip rate acquisition, which is used to detect OOK chips for the rest of the signal, and the chip synchronization. The clock acquisition part is a part of preamble.
Header: The header field carries necessary information for R2D or D2R signal reception, providing L1 or L2 control information
Payload: The field provides data including any of L1, L2, or higher layer control information, system information, etc.

The second figure in FIG. 33 illustrates a signal structure with midamble. When a transmission is longer than a certain threshold, which may be predefined in a specification of system operations or indicated to the device for reception or transmission from the device, the payload may be divided into multiple segments with midamble. A single header for the entire payload, or one or more headers for each segments of the payload may be provided. A single CRC for the entire payload (either inclusive or non-inclusive of the header) or one or more CRCs for each segments of the payload may be provided.

Given the low complexity and the low power consumption requirements for A-IoT devices, it is apparent that the oscillators equipped with A-IoT devices will be significantly subpar to that equipped with a normal NR UE. It is therefore impractical to expect a precise timing capability for A-IoT devices as it is usually expected for normal NR UEs. Furthermore, given that A-IoT devices are powered by harvesting energy, the device maybe running out of power time to time and, thereby, loosing timing, i.e., lacking timing maintaining capability.

The A-IoT reader may reuse the existing NR hardware for generating OOK signal based on underlying CP-OFDM waveform. This may be also intended for minimizing interference impact to existing other NR UEs served using CP-OFDM waveform. Therefore, there is a need to define procedures and methods for generating OOK signal based on underlying CP-OFDM waveform including aligning OOK signals into OFDM symbol boundary and attaching CP.

For OOK signal generation based on CP-OFDM waveform, the CP insertion can be still beneficial in terms of reusing the existing OFDM hardware for OOK signal generation and also for other UEs served using OFDM waveform by maintaining the sub-carrier orthogonality. However, the attachment of CP can introduce false falling and rising edges, which can be interpreted as an additional chip other than the intended signaling, or increase the length of the first chip in the OFDM symbol. Therefore, there is a need to define procedures and methods for a receiver to remove CP when the underlying OFDM symbol index is known.

The assumption on the receiver that it is aware of the underlying OFDM symbol index may not be achievable in some cases, and the receiver may need to handle the CP without knowing the underlying OFDM symbol index. Therefore, embodiments of the present disclosure recognize that there is a need to define procedures and methods for a receiver to handle CP when the underlying OFDM symbol index is unknown by assuming equal CP length across symbols. With the same motivation, embodiments of the present disclosure further recognize that there is another need to define procedures and methods for a receiver to handle CP when the underlying OFDM symbol index is unknown by detecting rising/falling edges.

The disclosure relates to a communication system. The disclosure relates to defining functionalities and procedures for communication with A-IoT devices which may be lacking a precise timing capability and may operate in a passive or active transmission mode.

The disclosure relates to defining functionalities and procedures for a transmitter to generate OOK signal based on CP-OFDM waveform.

The disclosure also relates to defining functionalities and procedures for a receiver to remove CP when the underlying OFDM symbol index is known.

The disclosure further relates to defining functionalities and procedures for a receiver to handle CP when the underlying OFDM symbol index is unknown by assuming equal CP length across symbols.

The disclosure also relates to defining functionalities and procedures for a receiver to handle CP when the underlying OFDM symbol index is unknown by detecting rising/falling edges.

Embodiments of the disclosure for communication with A-IoT devices, which may be lacking a precise timing capability and may operate in a passive or active UL transmission mode, are summarized in the following and are fully elaborated further herein.
Method and apparatus for a transmitter to generate OOK signal based on CP-OFDM waveform.
Method and apparatus for a receiver to remove CP when the underlying OFDM symbol index is known.
Method and apparatus for a receiver to handle CP when the underlying OFDM symbol index is unknown by assuming equal CP length across symbols.
Method and apparatus for a receiver to handle CP when the underlying OFDM symbol index is unknown by detecting rising/falling edges.

The general principle for OOK signal generation based on CP-OFDM waveform includes encoding OOK chips generated by encoding schemes on top of CM-OFDM waveform. Such encoding schemes include Manchester encoding, PIE (Pulse-Interval Encoding), Miller encoding, FMO encoding, any other types of line-coding schemes, or even no line-coding schemes such as based on square-wave modulation. The following OOK schemes based on CP-OFDM waveform can be evaluated.
OOK-1: Single-chip in 1 OFDM symbol. OOK=1 means N sub-carriers (SCs) are modulated. OOK=0 means SCs are zero power (from base-band point of view).
OOK-2: Parallel M-bit OOK in frequency domain. N SCs are further separated into M segments with guard-bands in-between and/or around. OOK=1 means SCs in segment are modulated. OOK=0 means SCs in segment are zero power (from base-band point of view).
OOK-3: Multi-tone single-bit OOK. N SCs are separated into L segments without guard-bands in-between segment, but around. OOK=1 means 1 sub-carrier (known by receiver) of each segment is modulated, rest of SC is zero power (from base-band point of view). OOK=0 means SCs in segments are zero power (from base-band point of view).
OOK-4: Transform M-bit OOK in time domain. N SCs of OOK-1 are generated by a transformation (DFT/Least square). N′ samples are generated from M-bits. Signal modification and/or truncation may or may not be used. The resulting samples, N, are mapped to N SCs.

The disclosure is applicable to any encoding schemes, any OOK modulation schemes with different M values if applicable, or any underlying waveforms such as CP-OFDM or its variants including DFT-s-OFDM, etc.

FIG. 18 illustrates an example CP-OFDM symbols in time domain (assuming 15 kHz SCS) according to the disclosure. The disclosure is applicable to any different values of SCS, such as 30/60/120 kHz, or any choice of CP lengths including extended CPs. In the example of FIG. 33, it is expected that a slot includes 14 symbols and the₀th and₇th symbols from the 14 symbols have long CP (L_{CP}) duration (5.21 us) compared to other symbols having normal CP (NCP) duration (4.69 us).

The OOK signal based on CP-OFDM waveform may be generated and transmitted by a reader and it is received by a device, or vice versa. For some examples, it is described that a reader takes the role of a transmitter and a device takes the role of a receiver, wherein the opposite is also feasible.

In one example for Manchester encoding, bit 0 is mapped to chips {10}and bit 1 is mapped to chips {O1}. The opposite is also feasible. For PIE encoding, bit 0 is mapped to chips {10}and bit 1 is mapped to chips {110), {1110), {100), or {1000), assuming fixed chip duration. If variable chip duration is taken into account, for PIE encoding both bit 0 and bit 1 are mapped to chips {10) (or {01)) but with different lengths of chip 1, or different lengths of chip 0, to distinguish bit 0 and bit 1. The representation of chip 1 or 0 is from a base-band point of view and they may correspond to high-voltage or low-voltage states from an actual transmission point of view.

For OOK-1 as an example, one chip, either 0 or 1, is encoded over one payload duration, denoted by Lₚₗ, and then the symbol is extended by prepending CP, by copying the last L_{CP} duration of the signal from the payload.

The length of a chip is equal to Lₚₗ/M, for OOK-4. In one embodiment, the supported Mvalues are upper bounded by Mₘₐₓ, such that L_{CP} is no longer than one chip duration, Lₚₗ/M. For NCP, Mₘₐₓ=14. For LCP, Mₘₐₓ=12. Thus, the supported M value may be limited to 12 in the specifications of system operation.

FIG. 34 illustrates a flowchart of an example procedure 3400 for CP removal according to embodiments of the present disclosure. For example, procedure 3400 can be performed by any of the receiver devices described herein. This example is for illustration only and other embodiments can be used without departing from the scope of the present disclosure.

In step 1, a receiver receives OOK signal based on CP-OFDM waveform and determines the underlying symbol indexes based on a prior knowledge or a received assistant information 3410. The receiver removes CP duration of the received signal from each corresponding symbol durations 3420. The receiver reads OOK chips from each symbol durations, and forward it to the following receiver block 3430.

The general principles for CP removal at a receiver for OOK signal when the underlying OFDM symbol index is known includes a transmitter generating OOK signal based on the normal CP operation, i.e., as in a OFDM system, and a receiver removes the CP prior to OOK signal detection based on the knowledge on the underlying OFDM symbol index. As the receiver may be lacking a precise timing maintenance capability, the receiver obtains the underlying OFDM symbol index based on a prior knowledge or an assistant information provided from the transmitter.

With reference to FIG. 34, an example flowchart of a receiver to remove CP from the received OOK signal when the underlying OFDM symbol index is known is shown according to the disclosure.

The example methods disclosed herein are for a receiver to obtain the underlying symbol indexes.
Based on a prior knowledge
   For a certain deployment scenario, e.g., standalone deployment, or system configuration, e.g., used encoding schemes such as Manchester, PIE, Miller, FMO, a receiver is preconfigured on whether CP-OFDM is used or not as an underlying waveform and, therefore, whether CP removal is necessary or not. As an example, for standalone deployment, the receiver recognizes that the received OOK signal is not based on CP-OFDM waveform and, therefore, does not perform CP removal prior to read the OOK signal.
   A receiver may expect that the OOK signal transmission is aligned with NR slot boundaries, or NR half-slot boundaries, i.e., aligned with NR symbol 1=0, 7, which may be predefined in a specification of system operations. Based on this assumption, the receiver determines that the first received symbol corresponds to L_{CP} and the following 6 symbols correspond to NCP and repeats. The receiver removes the determined the CP duration for each symbol accordingly.
Based on the assistant information
   Broadcast information, e.g., R2D broadcast information provided in a PRDCH or in a separate dedicated physical channel, provides the symbol index of the start of a current transmission providing the broadcast information or a following subsequent transmission.
   A preamble sequence, either the start-indicator part, the clock acquisition part, or both, from a set of sequences is associated with one or more symbol indexes. For example, a first sequence is associated with OFDM symbol indexes {0, 7}, and a second sequence is associated with OFDM symbol indexes {4, 11}. If the first sequence is detected, the receiver expects that the first received symbol corresponds to L_{CP} and the following 6 symbols correspond to NCP and repeats. If the second sequence is detected, the receiver expects that the first three symbols correspond to NCP, and then the pattern comprised of a symbol with L_{CP} and 6 symbols with NCP repeats. The receiver removes the determined the CP duration for each symbol accordingly. It can be generalized to cases with more than two sequences.
   A field having a fixed size in each transmission indicates its own symbol index. As an example, in the beginning of a transmission such as immediately following the preamble, there is a field having a fixed size indicating the symbol index of the start of the transmission, or the index of the symbol providing the field. When reading the symbol containing the filed, the receiver may expect NCP for CP removal.

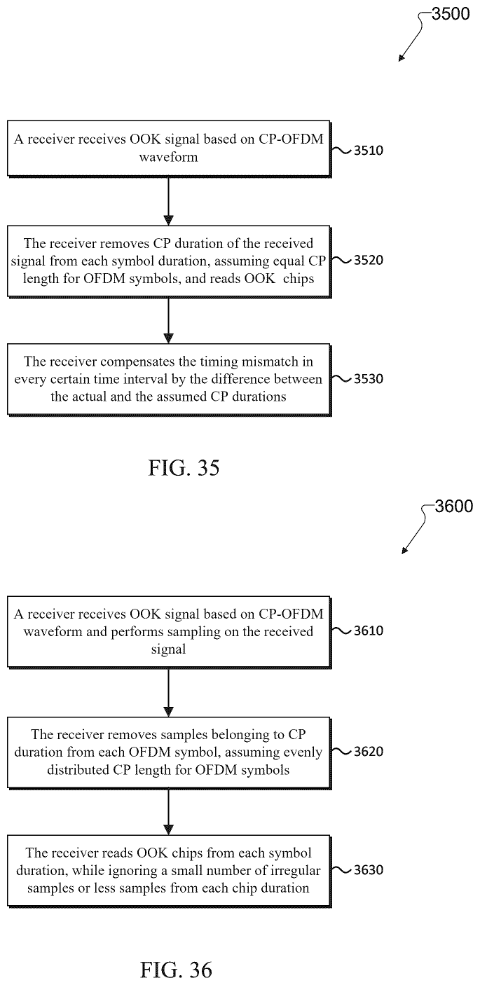

FIG. 35 illustrates a flowchart of an example procedure 3500 for CP removal according to embodiments of the present disclosure. For example, procedure 3500 can be performed by any of the receiver devices described herein, such as the IoT devices described herein. This example is for illustration only and other embodiments can be used without departing from the scope of the present disclosure.

In step 1, a receiver receives OOK signal based on CP-OFDM waveform 3510. In step 2, the receiver removes CP duration of the received signal from each symbol duration, assuming equal CP length for OFDM symbols, and reads OOK chips 3520. In step 3, the receiver compensates the timing mismatch in every certain time interval by the difference between the actual and the expected/assumed CP durations 3530.

Without a prior knowledge or assistant information, a receiver is agnostic to the underlying OFDM symbol indexes. The general principles for CP removal at a receiver for OOK signal when the underlying OFDM symbol index is unknown includes a transmitter generating OOK signal based on the normal CP operation, and a receiver removes the CP based on a certain assumption or by detecting the transition edges in the received OOK signal and, thereby, identifying CPs by itself.

With reference to FIG. 35, an example flowchart of a receiver to remove CP from the received OOK signal assuming equal CP length to compensate the timing mismatch is shown according to the disclosure.

In one embodiment, a receiver expects equal CP length for each OFDM symbol and, therefore, it does not distinguish symbols with L_{CP} and symbols with NCP when removing CP from the received signal corresponding to one or more symbol durations. In one example, the receiver expects that the CP length is equal to NCP length, e.g., 4.69 us, for symbols and removes the CP from each symbol accordingly. In this case, the half-slot duration, comprised of 7 symbols, is expected to be less than the nominal duration of 0.5 ms by the difference between the length of L_{CP} (5.21 us) and that of NCP (4.69 us), which is about 0.52 us shorter. For a transmission with a relatively long duration, the timing error due to the mismatch between the actual symbol duration and the expected symbol duration can accumulate. Therefore, in one example, the receiver compensates the timing mismatch in every certain time interval, e.g., every half-slot, every slot or a number of slots, by shifting forward the expected OFDM symbol boundary by the amount of timing error.

FIG. 36 illustrates a flowchart of an example procedure 3600 for CP removal according to embodiments of the present disclosure. For example, procedure 3600 can be performed by any of the receiver devices described herein, such as the IoT devices described herein. This example is for illustration only and other embodiments can be used without departing from the scope of the present disclosure.

In step 1, a receiver receives OOK signal based on CP-OFDM waveform and performs sampling on the received signal 3610. In step 2, the receiver removes samples belonging to CP duration from each OFDM symbol, assuming evenly distributed CP length for OFDM symbols 3620. In step 3, the receiver reads OOK chips from each symbol duration, while ignoring a small number of irregular samples or less samples from each chip duration 3630.

With reference to FIG. 36, an example flowchart of a receiver to remove CP from the received OOK signal assuming equal CP length and to handle erroneous samples is shown according to the disclosure.

In another example, the receiver expects equal CP length for each OFDM symbol by evenly distributing the total CP duration over 7 symbols. That is, the expected equal CP length is given by (5.21+6*4.69)/7=4.76 us, while the payload length of each symbol remains the same as before, i.e., 66.67 us.

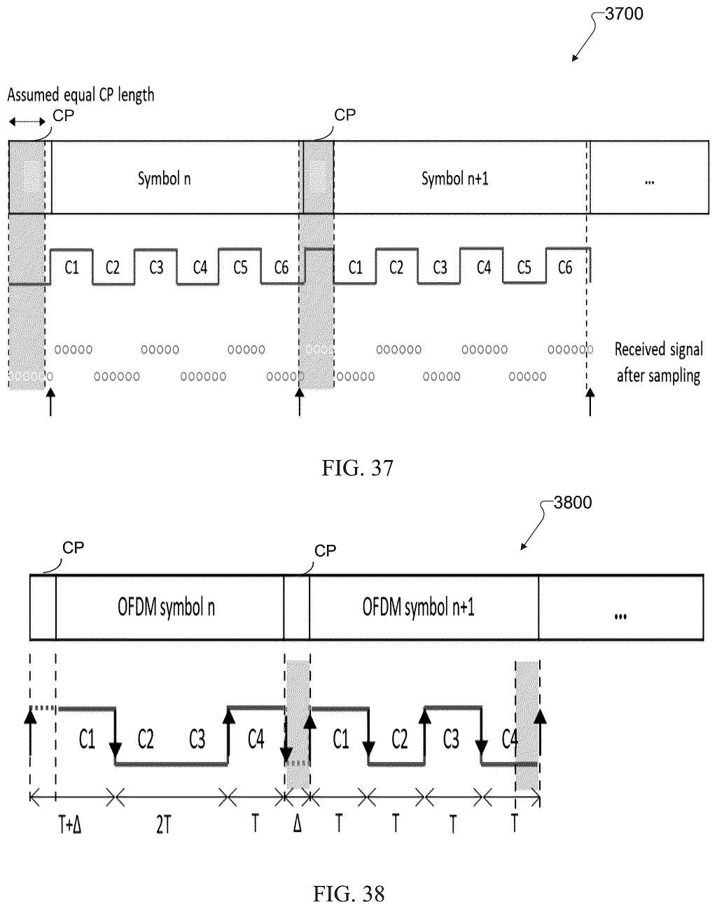

FIG. 37 illustrates example CP-OFDM symbols 3700 according to embodiments of the present disclosure. For example, CP-OFDM symbols 3700 can be received by any of the receiver devices described herein, such as the IoT devices described herein. This example is for illustration only and other embodiments can be used without departing from the scope of the present disclosure.

With reference to FIG. 37, an example of sampling the received OOK signal based on CP-OFDM waveform is shown according to the disclosure.

As an example, if the sampling rate is 1.92 MHz, there can be total 128 samples taken from the payload duration of an OFDM symbol and 9 or at most 10 samples from CP. On the other hand, for OOK-4 with M=8, there can be 16 samples taken per chip duration and, for OOK-4 with M=16, there can be 8 samples taken per chip duration.

Taking into account that the difference between the length of L_{CP} and that of NCP is 0.52 us, there can be only a small number of samples, which is one sample for the example of 1.92 MHz sampling rate, less removed from L_{CP} or more removed from NCP durations assuming evenly distributed CP length.

In FIG. 37, the received OOK signal is first sampled and, then, the samples regarded as CP are removed assuming that the total CP duration is evenly distributed over 7 symbols.

It is expected that the received OOK signal is OOK-4 with M=6 for an illustration purpose only, such as the actual number of samples taken from each chip duration can be different from the illustration.

After removing samples regarded as CP, it can be seen that there are cases such as
Case 1) A small number of samples erroneously left from the preceding expected CP duration, which may affect the detection of the following chip, e.g., C1 in symbol n.
Case 2) A small number of samples additionally removed from the following expected CP duration, which may affect the detection of the preceding chip, e.g., C6 in symbol n and symbol n+1.

The first number of samples erroneously left or additionally removed is relatively small compared to the second number of samples taken from each chip duration for a reasonably expected sampling rate.

In one embodiment, the receiver ignores a small number of samples, which are irregular from the rest of samples, for a given chip duration when reading the OOK chip value. In one example, depending on the OOK receiver implementation such as based on rising and falling edge detection, these irregular samples may be disregarded inherently.

In another embodiment, the receiver ignores a small variation in number of samples for a given chip duration, e.g., a smaller number of samples than the expected number of samples, when reading the OOK chip value. In one example, depending on the OOK receiver implementation such as based on rising and falling edge detection, these smaller samples for a given chip duration may be disregarded inherently.

In one embodiment, the receiver removes the CP from each OFDM symbol duration by detecting the transition edges in the received OOK signal.

FIG. 38 illustrates a timeline 3800 of example OOK chip detection according to embodiments of the present disclosure. For example, timeline 3800 can be followed by any of the receiver devices described herein, such as the IoT devices described herein. This example is for illustration only and other embodiments can be used without departing from the scope of the present disclosure.

With reference to FIG. 38, an example of OOK chip detection without CP removal is shown according to the disclosure. T denotes the nominal chip length. The actual chip length may have a slight variation from its nominal value, i.e., T±6. A denotes the nominal CP length, which may also have a slight variation. The time may be measured in an absolute time in a analog domain prior to sampling, or in a discrete time in the unit of sampling time interval after sampling. The variation may be due to inaccurate clocks at the transmitter or receiver, signal propagation, or sampling timing.

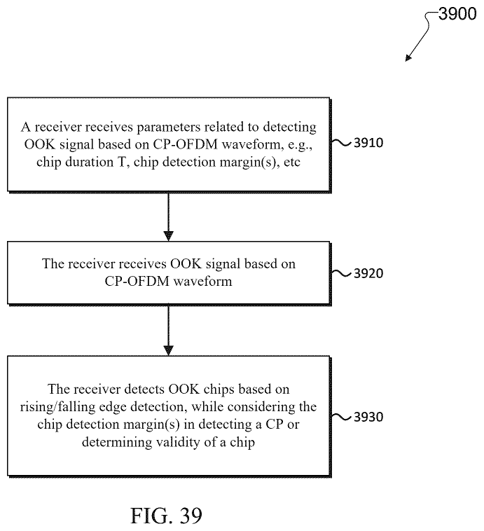

FIG. 39 illustrates a flowchart of example procedure 3900 for OOK signal detection according to embodiments of the present disclosure. For example, procedure 3900 can be performed by any of the receiver devices described herein, such as the IoT devices described herein. This example is for illustration only and other embodiments can be used without departing from the scope of the present disclosure.

In step 1, a receiver receives parameters related to detecting OOK signal based on CP-OFDM waveform, e.g., chip duration T, chip detection margin(s), etc. 3910. In step 2, the receiver receives OOK signal based on CP-OFDM waveform 3920. In step 3, the receiver detects OOK chips based on rising/falling edge detection, while taking into account the chip detection margin(s) in detecting a CP or determining validity of a chip 3930.

With reference to FIG. 39, an example flowchart of a receiver to detect OOK signal based on rising/falling edge detection and CP handling is shown according to the disclosure.

Based on the rising/falling edge detection, the OOK chips can be detected as
A chip with duration T+Δ, e.g., C1 in symbol n, due to CP having the same value with the chip.
A chip with duration Δ, e.g., CP in symbol n+1, due to CP having different value with the neighboring chips.
A chip with duration T, 2T, . . . , etc., which are normal chips.

In one embodiment, the receiver detects a CP based on the detection of chips with irregular duration. In one example, if a detected chip duration is A, which may be further associated with relative variation parameter δ such that the detected chip duration falls into [A-δ, A+δ], the receiver identifies that the corresponding chip as a CP and ignores it. In another example, if a detected chip duration is T+Δ, which may be further associated with relative variation parameter δ such that the detected chip duration falls into [T+Δ−δ, T+Δ+δ], the receiver identifies that the corresponding chip is composed of CP plus a normal chip and ignores the CP. Otherwise, the detection decision is made based on the nominal chip duration T and an integer multiples of T. In one example, Δ is equal to NCP duration. In another example, Δ is equal to L_{CP} duration. In yet another example,Δ is equal to average CP duration assuming equally distributed over a number of symbols. In yet another example, a pair of A values are used, one for NCP, and the other for LCP.

In one embodiment, the receiver detects OOK chips in one or more of the following manners:
A chip with duration in the range of [0, T_{Δ1}]is regarded as invalid and ignored.
A chip with duration in the range of [T - T_{Δ2}, T+T_{Δ3}]is regarded as a single chip.
A chip with duration in the range of [2T - T_{Δ4}, 2T+T_{Δ5}]is regarded as two chips.
and so on.

In one example, the timing margins, T_{Δ1}, T_{Δ2}, T_{Δ3}, T_{Δ4}, T_{Δ5}, . . . , have the same value. In one example, the timing margins are related to the CP duration Δ, e.g., equal to CP duration Δ, or Δ plus additional margin which may be in an absolute amount of time, e.g., us, or in a percentage of Δ. In another example, the timing margins are related to the chip length T, e.g., a certain percentage of chip length T. For instance, the timing margins are 0.5T, i.e., half of the chip length.

In one embodiment, there is a restriction on the supported OOK M values such that the CP duration remains relatively smaller than a used chip duration. As an example, for Δ=0.5T, in order for a CP duration to remain smaller than Δ, the maximum supported M value, Mₘₐₓ is 7 when taking into account normal CP length of 4.69 us and 6 when taking into account long CP length of 5.21 us. For instance, Mₘₐₓ=6 and the value is predefined in a specification of system operations. If M={1, 2, 4, 6}are supported, a receiver is indicated the OOK M value using two-bit indication.

One or more parameters from the parameters listed herein can be predefined in a specification of system operation or indicated to the receiver, e.g., via L1/L2 or any higher layer signaling, for instance, using PRDCH.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for an Internet of Things (IoT) device to communicate with a reader, the method comprising:
receiving a preamble signal, wherein the preamble signal comprises:
a start indicator part (SIP), and
a clock acquisition part (CAP),
receiving a physical reader-to-device channel (PRDCH); and
receiving a postamble signal,
wherein:
the preamble signal, the PRDCH, and the postamble signal are on-off keying (OOK) modulated based on an orthogonal frequency-division multiplexing (OFDM) waveform,
the preamble signal is followed by the PRDCH without a gap,
the PRDCH is followed by the postamble signal without a gap, and
when the postamble signal ends during an OFDM symbol duration, a padding signal is included from the end of the postamble signal for a remainder of the OFDM symbol duration.

2. The method of claim 1, wherein the CAP is an OOK modulated sequence of 1010.

3. The method of claim 1, wherein the CAP starts at an OFDM symbol boundary.

4. The method of claim 1, wherein:
the SIP is an OOK modulated sequence, and
the SIP starts and ends at OFDM symbol boundaries.

5. The method of claim 1, wherein the PRDCH provides, via higher layer signaling, information related to a size of the PRDCH for determining an end of a transmission of the PRDCH.

6. The method of claim 1, wherein:
the PRDCH comprises i) a medium access control (MAC) header providing control information and ii) a payload providing data, and
the PRDCH includes a number of cyclic redundancy check (CRC) parity bits calculated for both the MAC header and the payload.

7. The method of claim 1, further comprising:
determining, based on the reception of the PRDCH, a transmission of a physical device-to-reader channel (PDRCH); and
transmitting the PDRCH, wherein an entirety of the PDRCH is block-wise repeated once or twice.

8. An Internet of Things (IoT) device comprising:
a transceiver configured to:
receive a preamble signal, wherein the preamble signal comprises:
a start indicator part (SIP), and
a clock acquisition part (CAP),
receive a physical reader-to-device channel (PRDCH); and
receive a postamble signal,
wherein:
the preamble signal, the PRDCH, and the postamble signal are on-off keying (OOK) modulated based on an orthogonal frequency-division multiplexing (OFDM) waveform,
the preamble signal is followed by the PRDCH without a gap,
the PRDCH is followed by the postamble signal without a gap, and
when the postamble signal ends during an OFDM symbol duration, a padding signal is included from the end of the postamble signal for a remainder of the OFDM symbol duration.

9. The IoT device of claim 8, wherein the CAP is an OOK modulated sequence of 1010.

10. The IoT device of claim 8, wherein the CAP starts at an OFDM symbol boundary.

11. The IoT device of claim 8, wherein:
the SIP is an OOK modulated sequence, and
the SIP starts and ends at OFDM symbol boundaries.

12. The IoT device of claim 8, wherein the PRDCH provides, via higher layer signaling, information related to a size of the PRDCH for determining an end of a transmission of the PRDCH.

13. The IoT device of claim 8, wherein:
the PRDCH comprises i) a medium access control (MAC) header providing control information and ii) a payload providing data, and
the PRDCH includes a number of cyclic redundancy check (CRC) parity bits calculated for both the MAC header and the payload.

14. The IoT device of claim 8, further comprising:
processing circuitry configured to determine, based on the reception of the PRDCH, a transmission of a physical device-to-reader channel (PDRCH),
wherein the transceiver is further configured to transmit the PDRCH, and
wherein an entirety of the PDRCH is block-wise repeated once or twice.

15. A reader comprising:
a transceiver configured to:
transmit a preamble signal, wherein the preamble signal comprises:
a start indicator part (SIP), and
a clock acquisition part (CAP),
transmit a physical reader-to-device channel (PRDCH); and
transmit a postamble signal,
wherein:
the preamble signal, the PRDCH, and the postamble signal are on-off keying (OOK) modulated based on an orthogonal frequency-division multiplexing (OFDM) waveform,
the preamble signal is followed by the PRDCH without a gap,
the PRDCH is followed by the postamble signal without a gap, and
when the postamble signal ends during an OFDM symbol duration, a padding signal is included from the end of the postamble signal for a remainder of the OFDM symbol duration.

16. The reader of claim 15, wherein the CAP is an OOK modulated sequence of 1010.

17. The reader of claim 15, wherein the CAP starts at an OFDM symbol boundary.

18. The reader of claim 15, wherein:
the SIP is an OOK modulated sequence, and
the SIP starts and ends at OFDM symbol boundaries.

19. The reader of claim 15, wherein the PRDCH provides, via higher layer signaling, information related to a size of the PRDCH indicating an end of the transmission of the PRDCH.

20. The reader of claim 15, wherein:
the PRDCH comprises i) a medium access control (MAC) header providing control information and ii) a payload providing data, and
the PRDCH includes a number of cyclic redundancy check (CRC) parity bits calculated for both the MAC header and the payload.
